(19) United States
(12) Patent Application Publication
(10) Pub. No.: US 2023/0286270 A1
(43) Pub. Date: Sep. 14, 2023

(54) LIQUID DISCHARGE APPARATUS

(71) Applicant: BROTHER KOGYO KABUSHIKI KAISHA, Nagoya (JP)

(72) Inventors: MIKIO OGAWA, Nagoya (JP); RIKUTO MITOKA, Nagoya (JP); MOTOKI YAMADA, Ichinomiya (JP); KIYOTO MIZOGUCHI, Kariya (JP)

(73) Assignee: BROTHER KOGYO KABUSHIKI KAISHA, Nagoya (JP)

(21) Appl. No.: 18/179,542

(22) Filed: Mar. 7, 2023

(30) Foreign Application Priority Data
Mar. 9, 2022 (JP) 2022-035795

(51) Int. Cl. B41J 2/14; B41J 2/165; B41J 2/045; B41J 29/02

(52) U.S. Cl. CPC B41J 2/14024; B41J 2/16511; B41J 2/04531; B41J 29/02

(57) ABSTRACT

There is provided a liquid discharge apparatus including: a head having a nozzle surface and a nozzle opened in the nozzle surface; a cap configured to make contact with the nozzle surface at a covering position and configured to be separated away from the nozzle surface at a retreating position; a liquid channel configured to communicate an internal space of the cap and outside of the cap to each other; a lid member configured to make contact with the cap located at the retreating position so as to seal the internal space of the cap; and a heater which is positioned above the cap located at the retreating position. The lid member is positioned between the heater and the cap in an up-down direction in a state that the lid member seals the internal space of the cap.

### REFERENCE TO RELATED APPLICATIONS

This application claims priority from Japanese Patent Application No. 2022-035795 filed on Mar. 9, 2022. The entire content of the priority application is incorporated herein by reference.

### BACKGROUND ART

Conventionally, as the liquid discharge apparatus which performs printing on a sheet by discharging or ejecting a liquid from a nozzle of a head, there is a publicly known ink-jet printer. A certain publicly known ink-jet printer has a cap which caps an ink discharge port formation surface of a recording head, and a pressure contacting member which is brought into pressurized contact with a pressure contacting surface of the cap.

In another publicly known ink-jet printer, a heater is attached to a lower surface of a flat plate part of a platen, and an ink droplet adhered to the platen, without landing on a sheet, is dried by the heater.

### DESCRIPTION

In a case that an exhausting (discharging) operation of forcibly exhausting an ink from a head to the cap is performed for maintenance of the head, the ink remains in an internal space of the cap. Although the ink which remains in the internal space of the cap is exhausted from the internal space of the cap through a flow channel (channel), an ink droplet remains in the internal space of the cap. In a case that the heater and the cap are located, respectively, at positions which are relatively close to each other in the inside of a casing of the liquid discharge apparatus, there is such a fear that the heat from the heater might be transmitted to the cap, and that the ink might be dried and solidified in the internal space of the cap and/or the flow channel. As a result, there might arise such a problem that the flow channel is clogged by the solidified ink.

An object of the present disclosure is to provide a liquid discharge apparatus in which a liquid is less likely to be dried in the internal space of the cap even in a case that the heater and the cap are arranged relatively close to each other.

According to an aspect of the present disclosure, there is provided a liquid discharge apparatus including: a head including a nozzle surface and a nozzle opened in the nozzle surface; a cap configured to make contact with the nozzle surface at a covering position and configured to be separated away from the nozzle surface at a retreating position; a liquid channel configured to communicate an internal space of the cap and outside of the cap to each other; a lid member configured to make contact with the cap located at the retreating position so as to seal the internal space of the cap; and a heater which is positioned above the cap located at the retreating position. The lid member is positioned between the heater and the cap in an up-down direction in a state that the lid member seals the internal space of the cap.

According to the above-described configuration, since the lid member makes contact with the cap located at the retreating position and thus the internal space is sealed by the lid member, the heat of the heater which is located above the cap is blocked or shielded by the lid member. Further, the internal space of the cap is sealed by the lid member. Therefore, although the cap is heated by the heat of the heater, the liquid is less likely to evaporate and the channel in the cap is less likely to be clogged since the cap is sealed by the lid member.

According to the present disclosure, the liquid is less likely to be dried in the internal space of the cap.

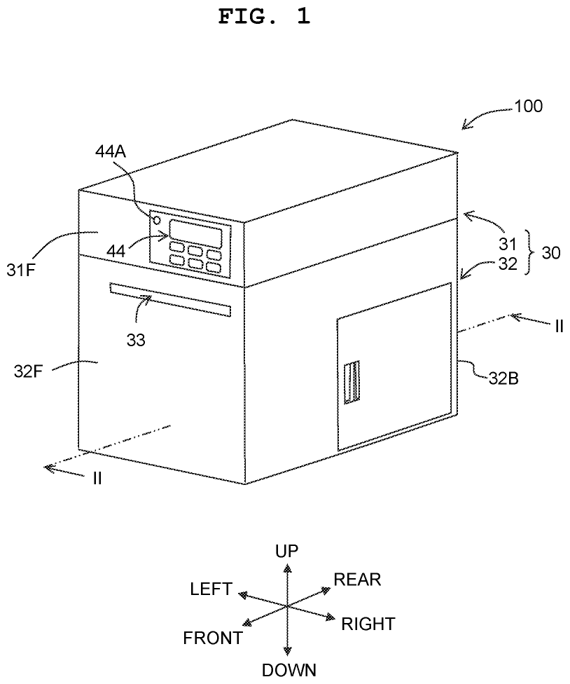

FIG. 1 is a perspective view depicting the outer appearance of an image recording apparatus 100.

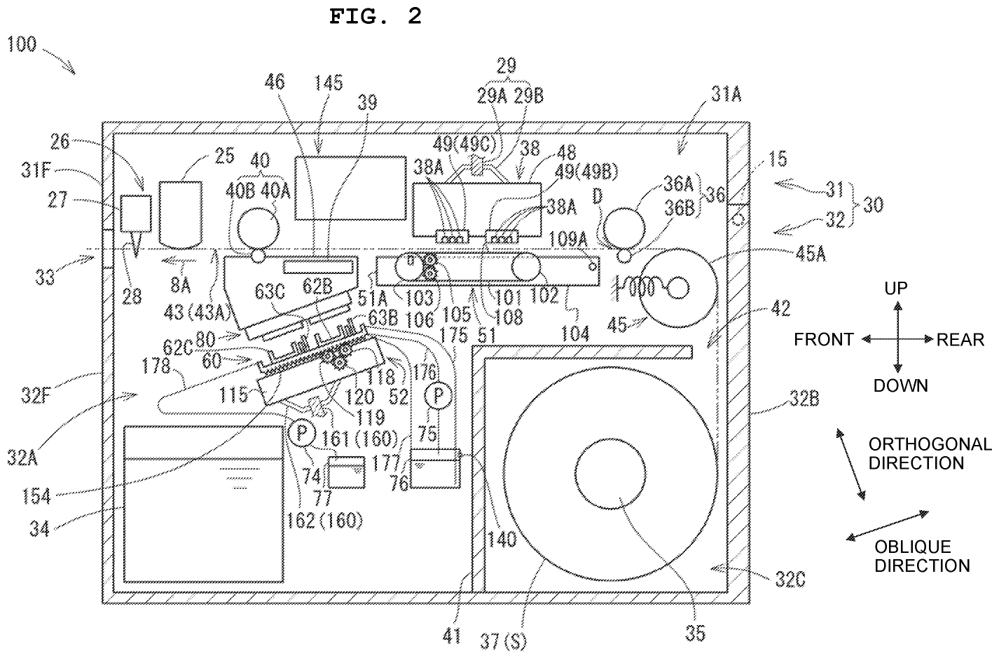

FIG. 2 is a cross-sectional view depicting a II-II cross section of FIG. 1 and depicting a state that a head 38 is at a recording position, a first supporting mechanism 51 is in a first posture and a maintenance mechanism 60 is at a standby position.

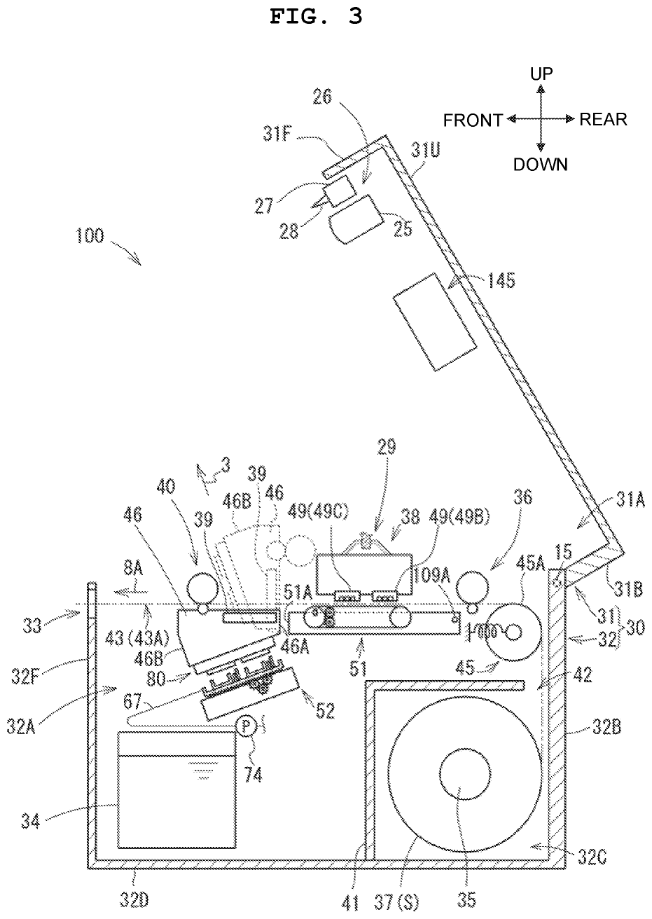

FIG. 3 is a cross-sectional view depicting a state that an upper casing 31 is at an open position in FIG. 2.

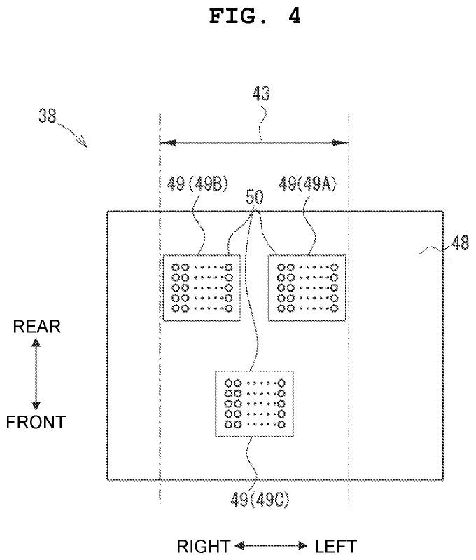

FIG. 4 is a bottom view of the head 38.

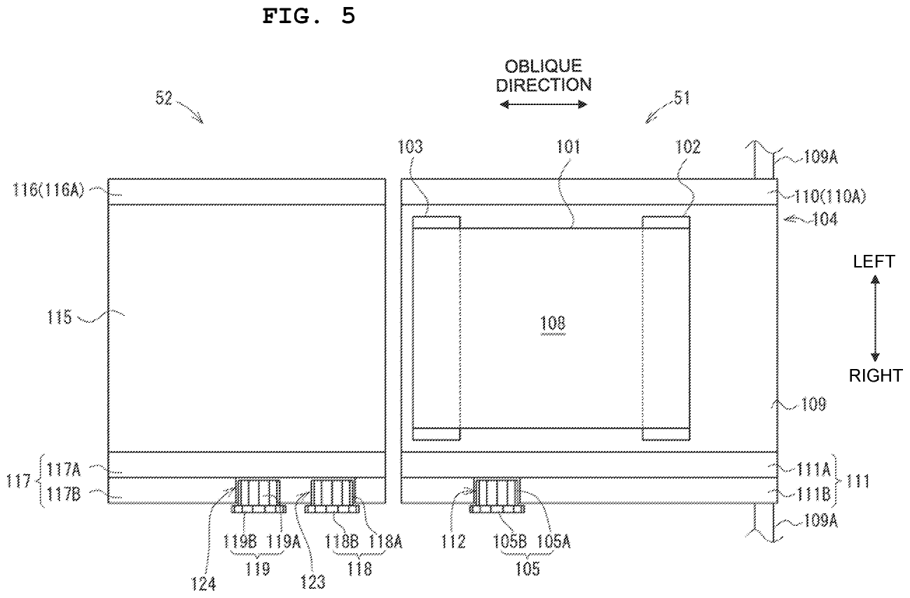

FIG. 5 is a plan view of the first supporting mechanism 51 which is in a second posture and a second supporting mechanism 52.

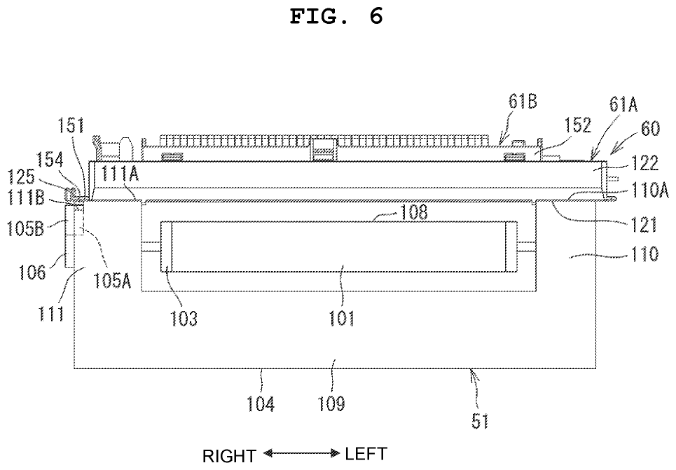

FIG. 6 is a front view of the first supporting mechanism 51 which is in the second posture and the maintenance mechanism 60.

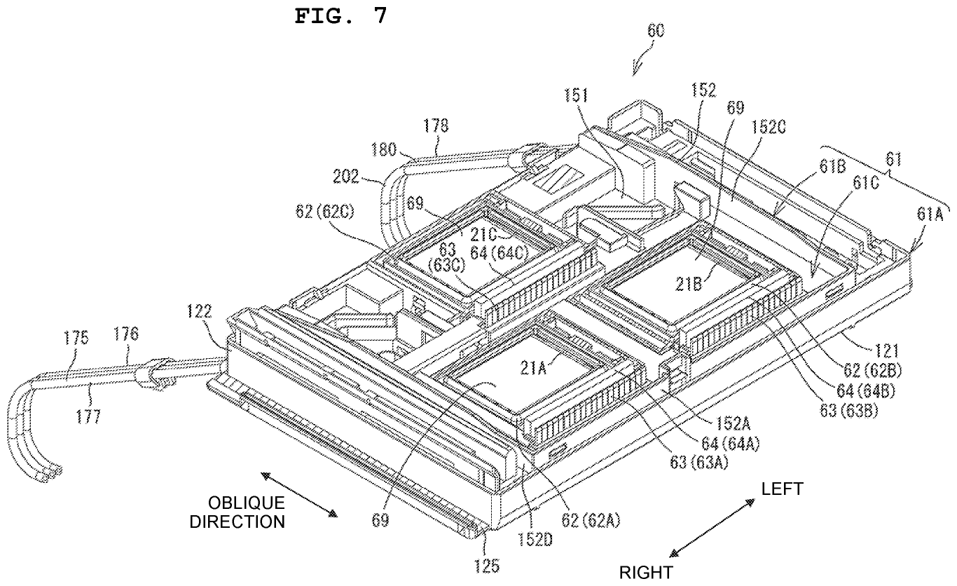

FIG. 7 is a perspective view of the maintenance mechanism 60.

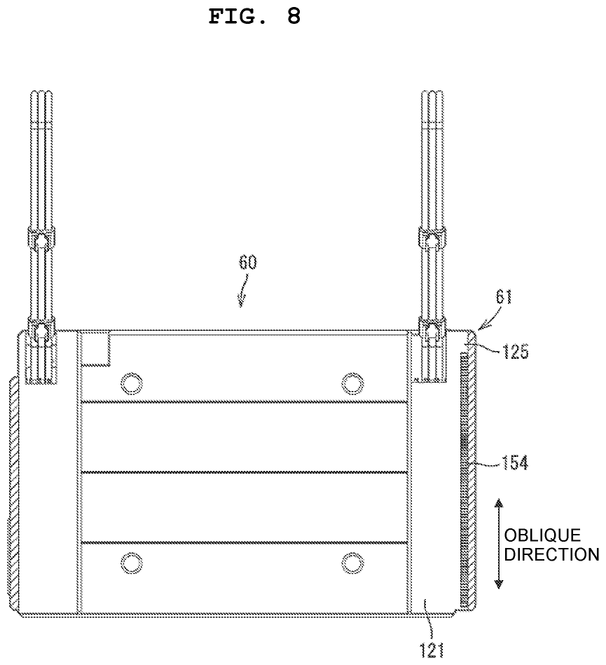

FIG. 8 is a bottom view of the maintenance mechanism 60.

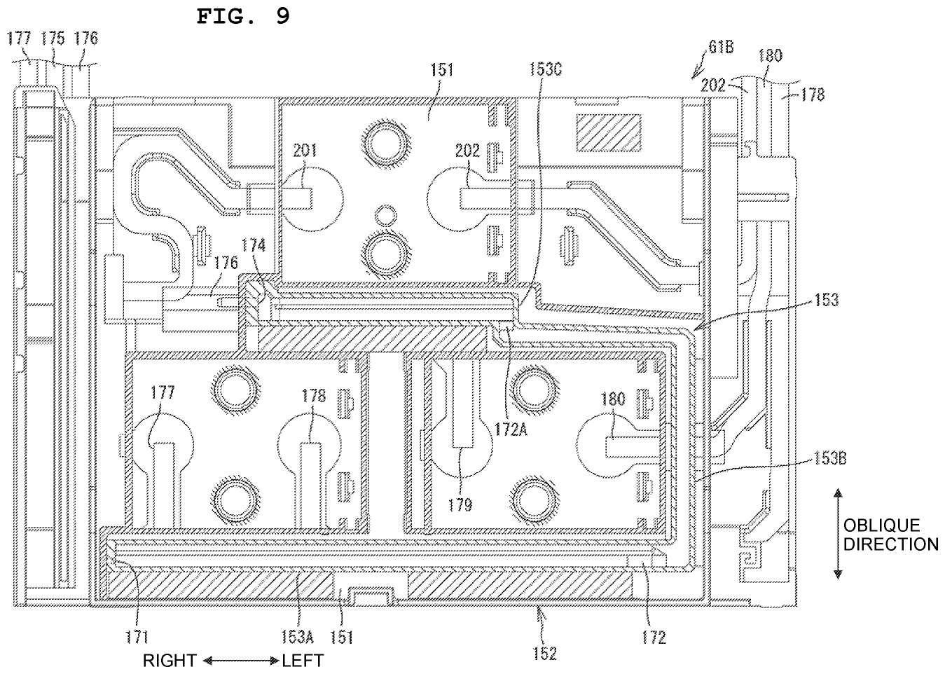

FIG. 9 is a cross-sectional view of a fluid channel 153 of a supporting stand 61 as being cut by a plane which is parallel to a flow direction in the fluid channel 153.

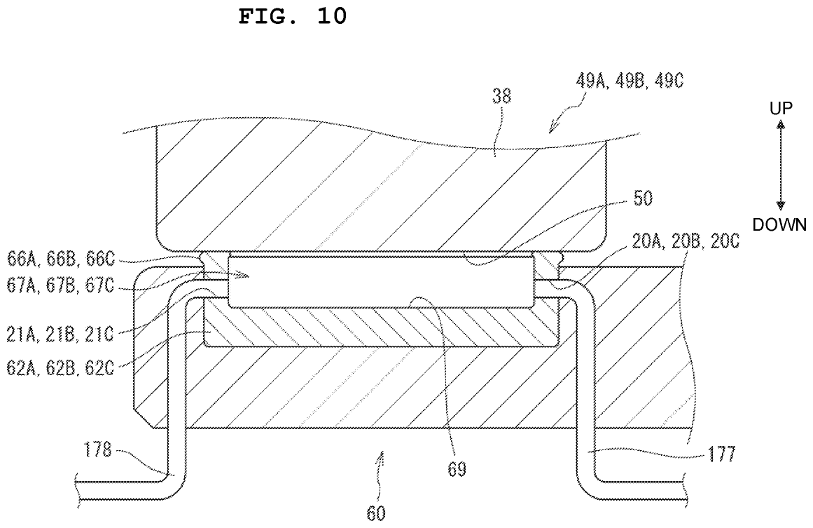

FIG. 10 is a cross-sectional view of caps 62A, 62B and 62C at a maintenance position.

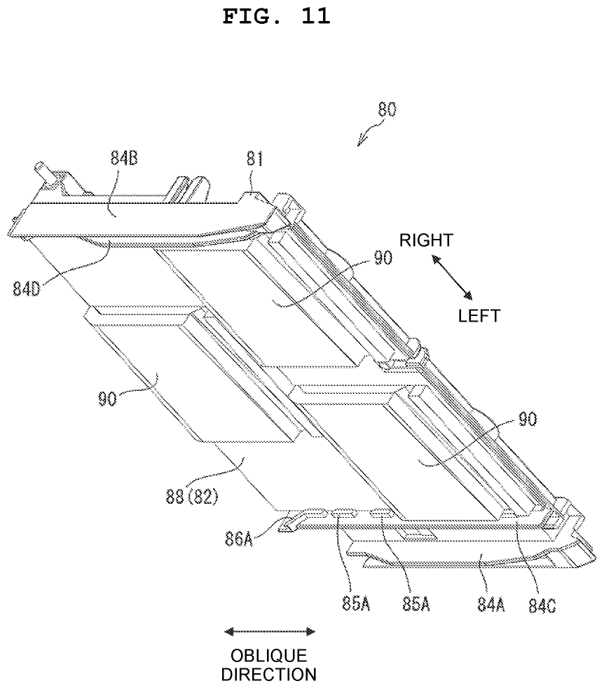

FIG. 11 is a perspective view of a wiper cleaning mechanism 80 as seen from obliquely therebelow.

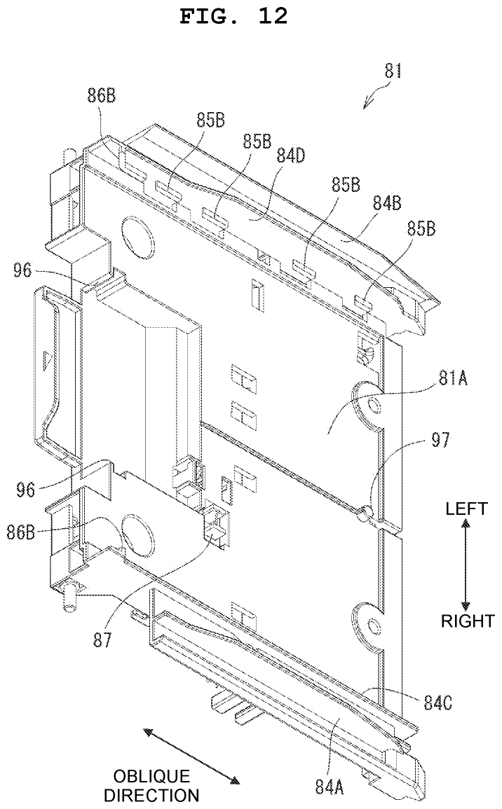

FIG. 12 is a perspective view of a supporting member 81.

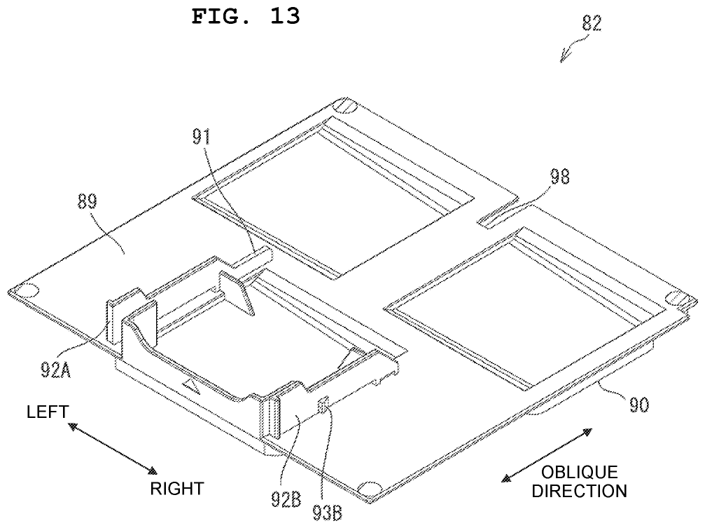

FIG. 13 is a perspective view of a lid member 82.

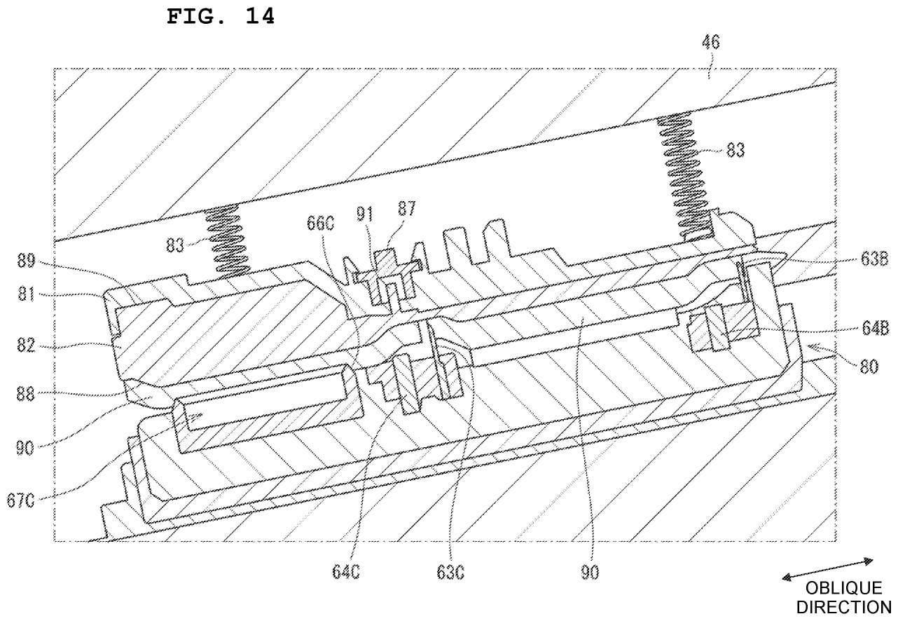

FIG. 14 is an enlarged view depicting a part of the wiper cleaning mechanism 80.

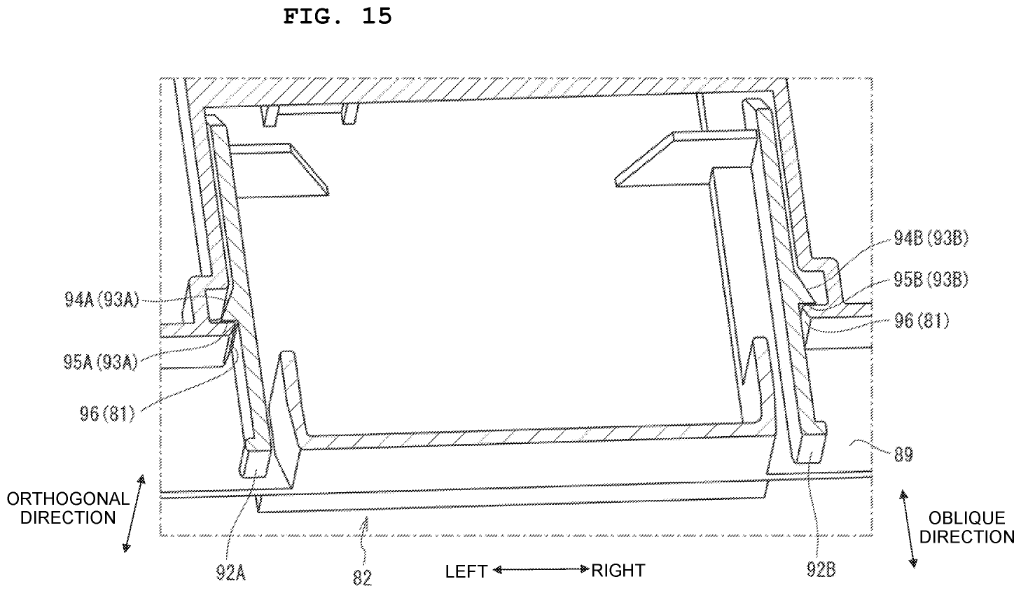

FIG. 15 is a cross-sectional perspective view depicting an engaging part 93 and an operating part 92 of the lid member 82.

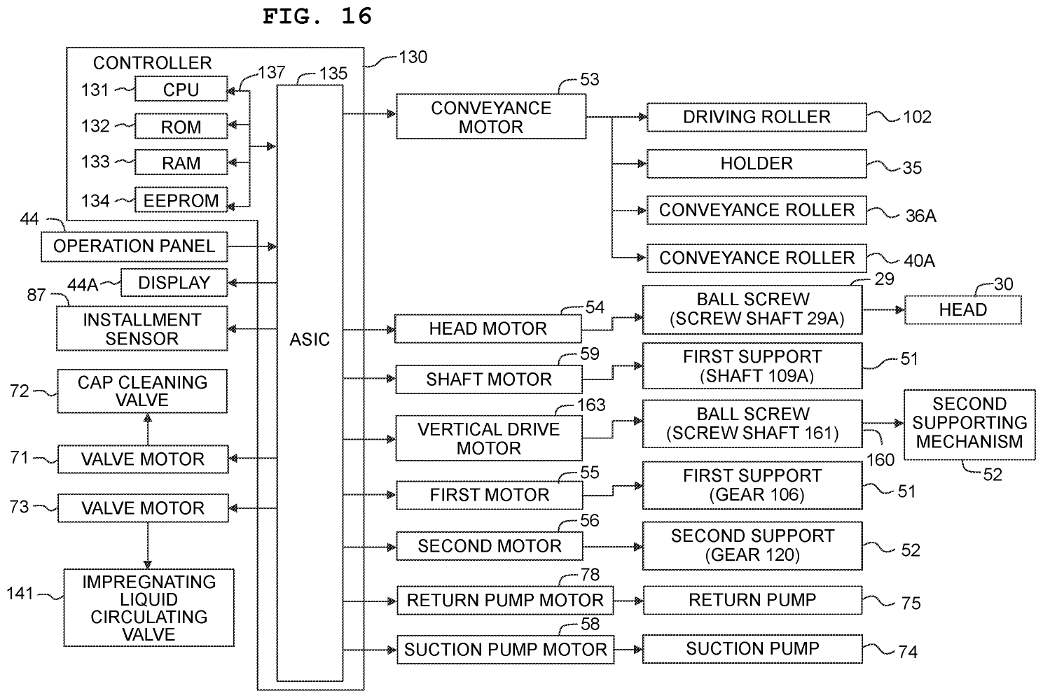

FIG. 16 is a block diagram of the image recording apparatus 100.

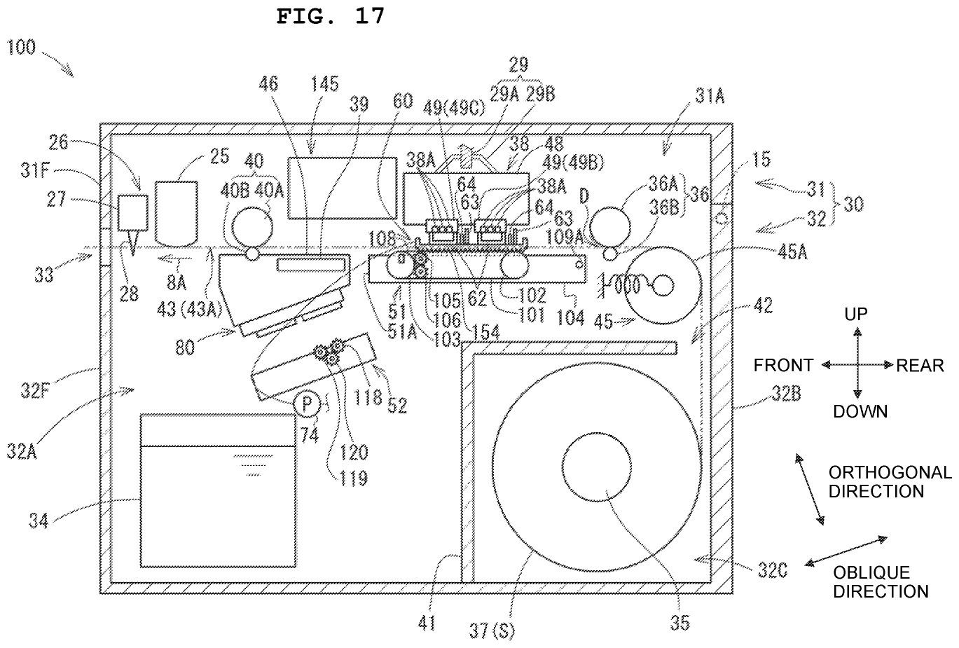

FIG. 17 is a cross-sectional view depicting the II-II cross section of FIG. 1, depicting a state that the head 38 is at a capping position, the first supporting mechanism 51 is in the first posture and the maintenance mechanism 60 is at the maintenance position.

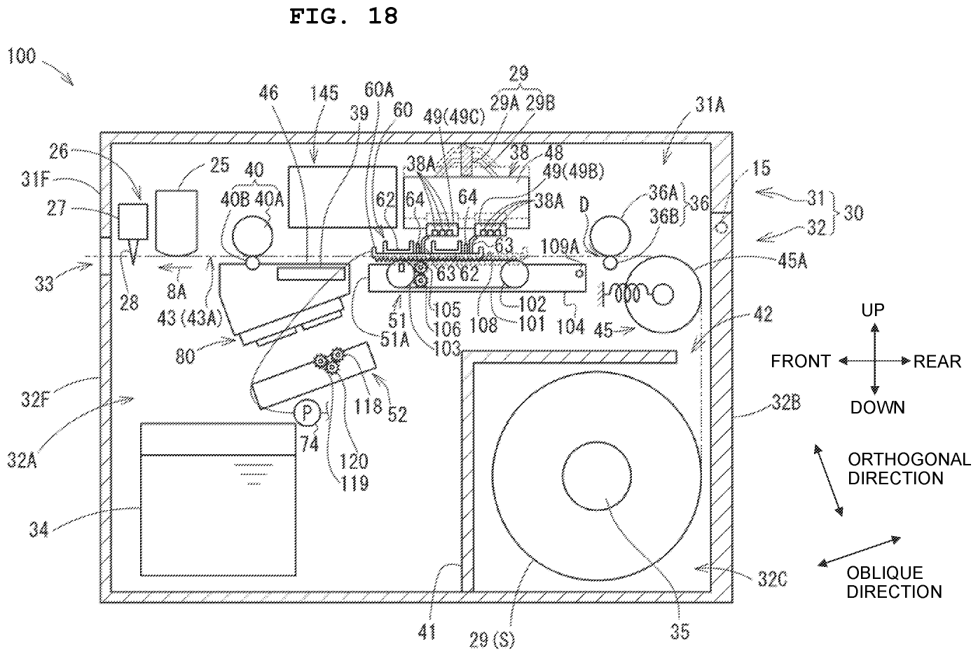

FIG. 18 is a cross-sectional view depicting the II-II cross section of FIG. 1, depicting a state that the head 38 is at a wiping position, the first supporting mechanism 51 is in the first posture and the maintenance mechanism 60 is at the wiping position.

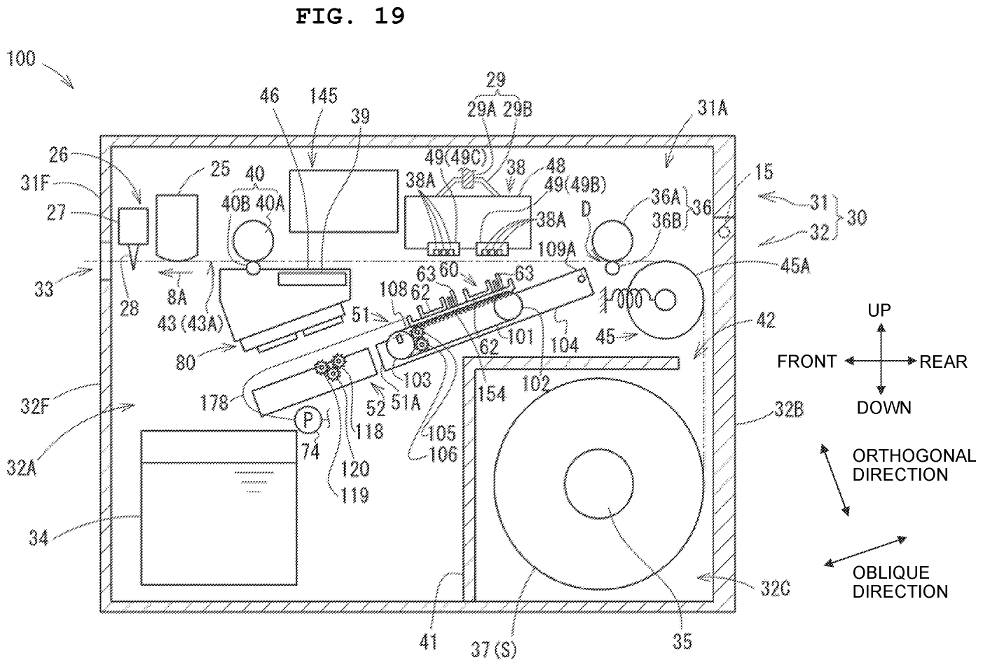

FIG. 19 is a cross-sectional view depicting the II-II cross section of FIG. 1, depicting a state that the head 38 is at the recording position, the first supporting mechanism 51 is in the second posture and the maintenance mechanism 60 is at a position at which the maintenance mechanism 60 is supported by the first supporting mechanism 51.

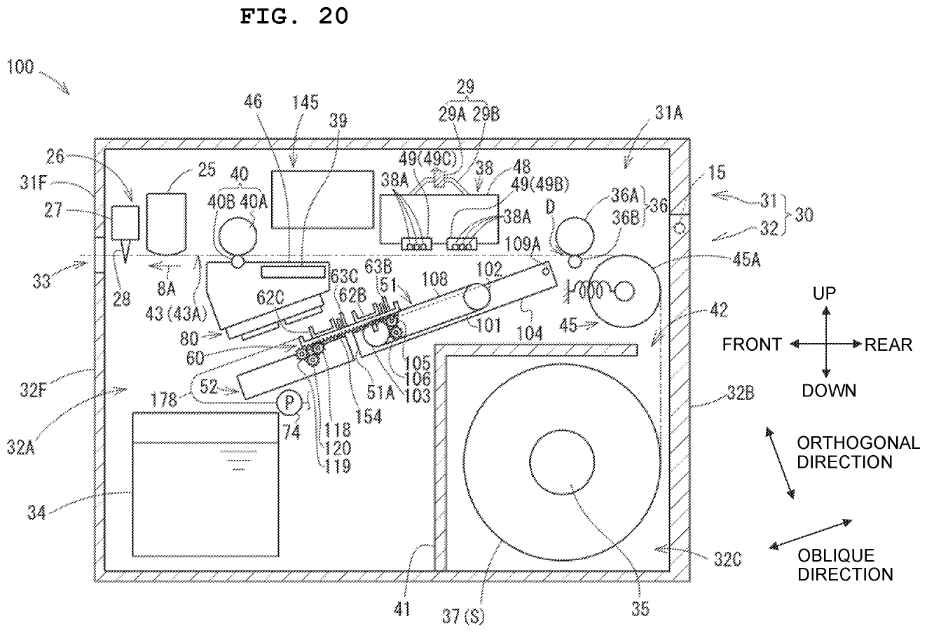

FIG. 20 is a cross-sectional view depicting the II-II cross section of FIG. 1, depicting a state that the head 38 is at the recording position, the first supporting mechanism 51 is in the second posture and the maintenance mechanism 60 is at a position which is between the standby position and the maintenance position.

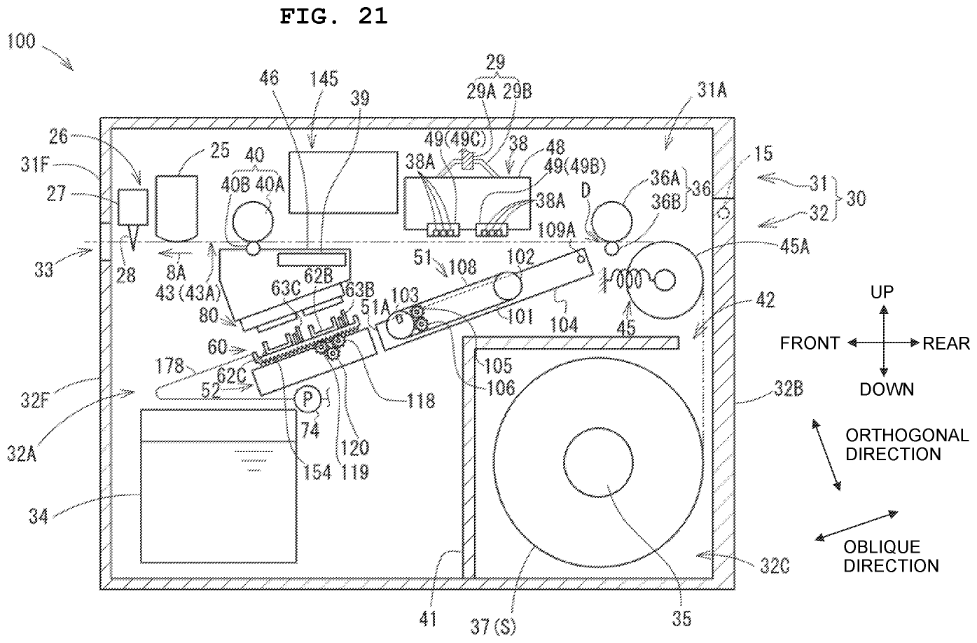

FIG. 21 is a cross-sectional view depicting the II-II cross section of FIG. 1, depicting a state that the head 38 is at the recording position, the first supporting mechanism 51 is in the second posture and the maintenance mechanism 60 is at the standby position.

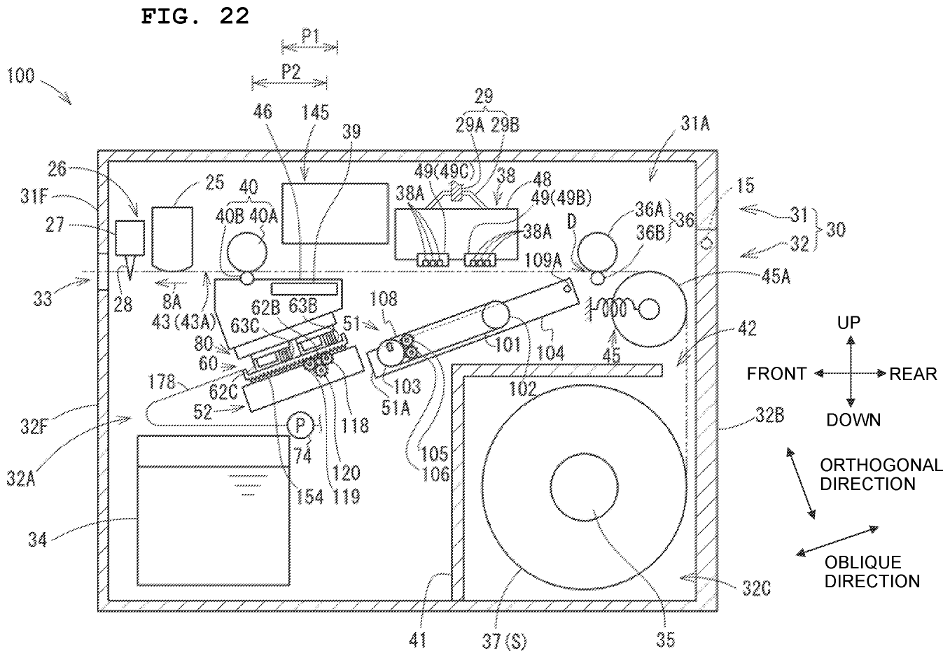

FIG. 22 is a cross-sectional view depicting the II-II cross section of FIG. 1, depicting a state that the head 38 is at the recording position, the first supporting mechanism 51 is in the second posture and the maintenance mechanism 60 is at a retreating position.

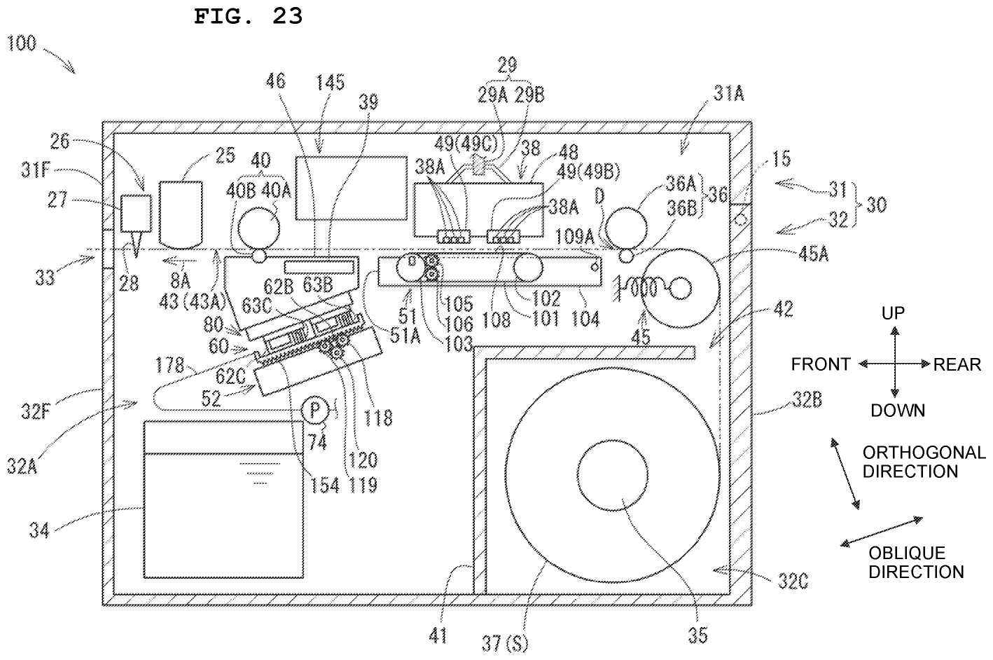

FIG. 23 is a cross-sectional view depicting the II-II cross section of FIG. 1, depicting a state that the head 38 is at the recording position, the first supporting mechanism 51 is in the first posture and the maintenance mechanism 60 is at the retreating position.

In the following, an embodiment of the present disclosure will be described. Note that the embodiment which is to be explained below is merely an example of the present disclosure; it is needless to say that the embodiment can be appropriately changed without changing the gist of the present disclosure. In the following explanation, an up-down direction is defined, with a state in which an image recording apparatus 100 is installed usably (a state of FIG. 1), as the reference; a front-rear direction is defined, with a side on which a discharge port 33 is provided is defined as a front side (front surface); and a left-right direction is defined, with the image recording apparatus 10 as seen from the front side (front surface).

<Outer Configuration of Image Recording Apparatus 100>

The image recording apparatus 100 as depicted in FIG. 1 records an image on a sheet (paper sheet, paper) S forming a roll body 37 (see FIG. 2), in the ink-jet recording system.

As depicted in FIG. 1, the image recording apparatus 100 is provided with a casing 30. The casing 30 has an upper casing 31 and a lower casing 32. The upper casing 31 and the lower casing 32 have a shape which is generally rectangular parallelepiped as a whole and have a size placeable or arrangeable on a table or desk. That is, the image recording apparatus 100 is suitable to be used by being placed on the table or desk. Of course, the image recording apparatus 100 may be used while being placed on a floor surface, a rack, etc.

As depicted in FIG. 2, in the casing 30, an internal space 31A is defined in the inside of the upper casing 31 and an internal space 32A is defined in the inside of the lower casing 32; the internal space 31A and the internal space 32A are demarcated or compartmentalized from the outside of the casing 30.

As depicted in FIGS. 2 and 3, the upper casing 31 is rotatably (pivotally) supported by the lower casing 32. The upper casing 31 is rotatable, about a rotation shaft 15 provided at a rear lower end part of the upper casing 31 and extending in the left-right direction, to a closed position depicted in FIG. 2 and to an open position depicted in FIG. 3.

As depicted in FIG. 1, the discharge port 33 which is slit-shaped and is long in the left-right direction is formed in a front surface 32 of the lower casing 32. A sheet S (an example of a “medium”, see FIG. 2) on which image recording has been performed is discharged from the discharge port 33.

An operation panel 44 is provided on a front surface 31F of the upper casing 31. A user performs input, via the operation panel 44, for operating the image recording apparatus 100 or for confirming a variety of kinds of settings. The operation panel 44 has a display 44 configured to indicate a lid member 82, which will be described later on, is installed in the supporting member 81.

<Internal Configuration of Image Recording Apparatus 100>

As depicted in FIG. 2, a holder 35, a tensioner 45, a conveying roller pair 36, a conveying roller pair 40, a head 38, a first supporting mechanism 51, a heater 39, a supporting part 46, a second supporting mechanism 52, a CIS 25, a cutter unit 26, an ink tank 34, an impregnating liquid tank 76, a waste liquid tank 77, a maintenance mechanism 60, a wiper cleaning mechanism 80 and a controller 130 (see FIG. 16) are arranged in the internal spaces 31A and 32A. Although not depicted in FIG. 2, the controller 130 is arranged in the internal space 32A (see FIG. 16). The controller 130 is configured to control an operation of the image recording apparatus 100.

The internal space 32A is provided with a partition wall 41. The partition wall 41 partitions a rear lower part of the internal space 32A so as to define or demarcate a sheet accommodating space 32C. The sheet accommodating space 32C is surrounded by the partition 41 and the lower casing 32.

The roll body 37 is accommodated in the sheet accommodating space 30C. The roll body 37 has a core tube and the sheet S which is elongated. The sheet S is wound around the core tube in a roll shape in the circumferential direction of the axial core of the core tube.

As depicted in FIG. 2, the holder 35 extending along the left-right direction is positioned in the sheet accommodating space 32C. In a case that the roll body 37 is installed in the holder 35, the holder 35 supports the roll body 37 such that the axial core of the core tube of the roll body 37 is along the left-right direction and that the roll body 37 is rotatable in the circumferential direction of the axial core of the core tube. The holder 35 is rotated by a driving force transmitted thereto from a conveying motor 53 (see FIG. 16). Accompanying with the rotation of the holder 35, the roll body 37 supported by the holder 35 also rotates.

As depicted in FIG. 2, the sheet accommodating space 32C is opened upward at a rear part of the sheet accommodating space 32C. A gap 42 is defined between the partition wall 41 and a rear surface 32B of the lower casing 32, that is, at a location above a rear end of the roll body 37. In a case that the conveying roller pairs 36 and 40 rotate, the sheet S is thereby drawn upward from the rear end of the roll body 37 and is guided to the tensioner 45 via the gap 42.

The tensioner 45 is positioned in the rear part of the internal space 32A, at a location above the partition wall 41. The tensioner 45 has an outer circumferential surface 45A facing the outside of the lower casing 32. An upper end of the outer circumferential surface 45A is at a position which is substantially same, in the up-down direction, as a nip D of the conveying roller pair 36.

The sheet S pulled out from the roll body 37 is put or placed on and makes contact with the outer circumferential surface 45A. The sheet S is curved forward along the outer circumferential surface 45A, extends in a conveyance direction, and is guided to the conveying roller pair 36. The conveyance direction is a forward orientation along the front-rear direction.

The conveying roller pair 36 is positioned in front of (on the front side of) the tensioner 45. The conveying roller pair 36 has a conveying roller 36A and a pinch roller 36B. The conveying roller 36A and the pinch roller 36B make contact with each other at a position in the up-down direction which is substantially same as the upper end of the outer circumferential surface 45A, to thereby form the nip D.

The conveying roller pair 40 is positioned in front of the conveying roller pair 36. The conveying roller pair 40 has a conveying roller 40A and a pinch roller 40B. The conveying roller 40A and the pinch roller 40B make contact with each other at a position in the up-down direction which is substantially same as the upper end of the outer circumferential surface 45A, to thereby form a nip.

The conveying rollers 36A and 40A rotate by the driving force transmitted thereto from the conveying motor 53 (see FIG. 16). The conveying roller pair 36 rotates while nipping the sheet S extending in the conveyance direction from the tensioner 45, to thereby feed out the sheet S in the conveyance direction which is along a conveying surface 43A of a conveyance path 43 (to be described later on). The conveying roller pair 40 rotates while nipping the sheet S fed from the conveying roller pair 36, to thereby feed out the sheet S in the conveyance direction. Further, by the rotations of the conveying roller pairs 36 and 40, the sheet S is drawn from the sheet accommodating space 32C via the gap 42 and toward the tensioner 45.

As depicted in FIG. 2, the conveyance path 43 extending from the upper end of the outer circumferential surface 45A and arriving at the discharge port 33 is formed in the internal space 32A. The conveyance path 43 extends substantially linearly along the conveyance direction, and is a space in which the sheet S can pass. Specifically, the conveyance path 43 is along a conveying surface 43A which spreads in the conveyance direction and in the left-right direction and which is long in the conveyance direction. Note that in FIG. 2, the conveying surface 43A is indicated by a two-dot chain line indicating the conveyance path 43. The conveyance path 43 is defined by non-illustrated guide members located away from each other in the up-down direction, the head 38, a conveying belt 101, the supporting part 46, the heater 39, etc. That is, the head 38, the conveying belt 101, the supporting member 46 and the heater 39 are positioned along the conveyance path 43.

The head 38 is positioned at a location above the conveyance path 43 and on the downstream side in the conveyance direction with respect to the conveying roller pair 36. The head 38 has a plurality of nozzles 38A which is opened in a nozzle surface 50 (see FIG. 4). From the plurality of nozzles 38A, an ink (an example of a “liquid”) is discharged or ejected downward toward the sheet S supported by the conveying belt 101. As a result, an image is recorded on the sheet S. The configuration of the head 38 will be explained later on.

The first supporting mechanism 51 is positioned at a location below the conveyance path 43 and on the downstream side in the conveyance direction with respect to the conveying roller pair 36. The first supporting mechanism 51 is located at a position below the head 38 and faces or is opposed to the head 38. The first supporting mechanism 51 has the conveying belt 101 and a supporting member 104. The conveying belt 101 supports the sheet S which is (being) conveyed in the conveyance direction by the conveying roller pair 36 and which is located immediately below the head 38. The conveying belt 101 conveys the sheet S which is supported thereby in the conveyance direction. The supporting member 104 is capable of supporting the maintenance mechanism 60. The configuration of the first supporting mechanism 51 will be explained later on.

The heater 39 is located at a position which is below the conveyance path 43, which is on the downstream side in the conveyance direction with respect to the head 38 and which is on the upstream side in the conveyance direction with respect to the conveying roller pair 40. The heater 39 is supported by a frame at a location in front of the first supporting mechanism 51 and extends in the left-right direction. The heater 39 has a heat transfer plate (not depicted in the drawings) and a film heater (not depicted in the drawings). The heat transfer plate is formed of metal, and has a supporting surface which spreads in the front-rear direction and the left-right direction at a position in the up-down direction which is substantially same as that of a conveying surface 108 of the conveying belt 101. The sheet S fed from the first supporting mechanism 51 is conveyed frontward on the supporting surface of the heat transfer plate. The film heater is fixed to a lower surface of the heat transfer plate, and generates heat under a control of the controller 130. This heat is transmitted, via the heat transfer plate, to the sheet S on the heat transfer plate. Further, the heat from the heater 39 is collected by a duct 145 arranged at a location above the heater 39.

Further, the duct 145 is located at a position which is above the conveyance path 43, which is on the downstream side in the conveyance direction with respect to the head 38 and which is on the upstream side in the conveyance direction with respect to the conveying roller pair 40.

The supporting part 46 is positioned below the conveyance path 43. The supporting part 46 is located on downstream side in the conveyance direction with respect to the head 38 and the first supporting mechanism 51. The heater 39 is positioned at a rear part of the supporting member 46. A front part of the supporting member 46 faces the conveying roller 40A. The supporting part 46 is located on the upstream side in the conveyance direction with respect to the cutter unit 26.

The supporting part 46 is supported, by the lower casing 32, to be rotatable about a axis or shaft (not depicted in the drawings) extending in the left-right direction. As depicted in FIG. 3, in a case that the upper casing 31 is positioned at the open position, the supporting part 46 is rotatable to a lodging position (falling position) indicated by solid lines in FIG. 3 and an upstanding position indicated by broken lines in FIG. 3.

In a case that the supporting part 46 is located at the lodging position, a rotation forward end 46B of the supporting part 46 is located at a position in front of (on the downstream side in the conveyance direction) with respect to a rotation proximal end 46A of the supporting part 46. In the case that the supporting part 46 is located at the lodging position, then the supporting member 46 constitutes a part of the conveyance path 43, and the supporting part 46 is capable of supporting the sheet S which is (being) conveyed in the conveyance direction by the conveying belt 101. In a case that the supporting member 46 is located at the upstanding position, then the rotation forward end 46B of the supporting part 46 is located at a position further above than that in the case that the supporting part 46 is located at the lodging position, and the maintenance mechanism 60 is allowed to be exposed to the outside. The axis of the supporting part 46 is provided on a rear end part of the supporting part 46, and extends in the left-right direction.

The second supporting mechanism 52 is supported by the lower casing 32 to be movable in an orthogonal direction which is orthogonal to an oblique direction and the left-right direction. The second supporting mechanism 52 is capable of supporting the maintenance mechanism 60. The configuration of the second supporting mechanism 52 will be explained later on.

The CIS 25 is positioned on the downstream side in the conveyance direction with respect to the conveying roller pair 40 at a location over or above the conveyance path 43. The CIS 25 is capable of reading an image on a print surface of the sheet.

The cutter unit 26 is located on the downstream side in the conveyance direction with respect to the CIS 25 at a location above the conveyance path 43. The cutter unit 26 has such a configuration wherein a cutter 28 is mounted on a cutter carriage 27. By the movement of the cutter 28, the sheet S located in the conveyance path 43 is cut along the left-right direction.

The ink tank 34 stores the ink. The ink is a liquid containing a pigment, etc. The ink is supplied from the ink tank 34 to the head 38 via a non-illustrated tube.

The impregnating liquid tank 76 stores an impregnating liquid L. The impregnating liquid L is a liquid for cleaning or washing the plurality of nozzles 38A of the head 38. The impregnating liquid tank 76 is located at a position below the second supporting mechanism 52 which will be described later. The impregnating liquid tank 76 has an atmospheric communicating channel 140 (see FIG. 2) which communicates an air layer formed in the impregnating liquid tank 76 to the outside. The impregnating liquid tank 76 has an impregnating liquid circulating valve 141 which opens and closes the atmospheric communicating channel 140. The waste liquid tank 77 is a container into which the impregnating liquid L is discharged or exhausted.

The maintenance mechanism 60 is configured to perform maintenance of the head 38. The maintenance mechanism 60 is configured to be movable; in a case that the maintenance of the head 38 is performed, the maintenance mechanism 60 is moved to a location immediately below the head 38 (See FIG. 17).

The maintenance of the head 38 includes a purging processing, a cap cleaning processing, a wiping processing, etc. As depicted in FIG. 17, the purging processing is a processing of covering the nozzle surface 50 by a cap 62 (to be described later on) of the maintenance mechanism 60 and then of sucking the ink from the plurality of nozzles 38A by a suction pump 74. The cap cleaning processing is a processing of cleaning or washing the nozzle surface 50 of the head 38 with the impregnating liquid L fed to internal spaces 67A, 67B and 67C of the cap 62 in a state that the nozzle surface 50 is covered by the cap 62. As depicted in FIG. 18, the wiping processing is a processing of wiping the nozzle surface 50 of the head 38 by a sponge wiper 64 (an example of a “water-absorbing wiper”; to be described later on) of the maintenance mechanism 60. The configuration of the maintenance mechanism 60 will be described later on.

The wiper cleaning mechanism 80 is configured to clean a rubber wiper 63 (an example of a “non-water absorbing wiper”) of the maintenance mechanism 60. The maintenance mechanism 60 is moved at a location immediately below the wiper cleaning mechanism 80 in a case that the rubber wiper 63 is (to be) cleaned. The configuration of the wiper cleaning mechanism 80 will be described later on.

<Head 38>

As depicted in FIGS. 2 and 4, the head 38 has a shape of a rectangular parallelepiped which is generally long in the left-right direction. The head 38 has the frame 48 and three ejection modules 49A, 49B, 49C. In the following, the three ejection modules 49A, 49B, 49C are collectively referred also to as an ejection module 49. The number (quantity) of the ejection module 49 is not limited to 3 (three), and may be, for example, 1 (one).

As depicted in FIGS. 2 and 4, the ejection module 49 is supported by the frame 48. A lower surface of the ejection module 49 is exposed downward. The ejection module 49 is arranged in the inside of the conveyance path 43 in the left-right direction.

As depicted in FIG. 4, the ejection modules 49A, 49B are arranged at a same position in the conveyance direction. The ejection modules 49A, 49B are arranged with a spacing distance therebetween in the left-right direction. The ejection module 49C is arranged on the downstream side in the conveyance direction with respect to the ejection modules 49A, 49B. The ejection module 49C is arranged between the ejection modules 49A, 49B which are two modules adjacent to each other in the left-right direction. A left end of the ejection module 49C is located on the left side with respect to a right end of the ejection module 49A. A right end of the ejection module 49C is arranged on the right side with respect to a left end of the ejection module 49B. In other words, in the left-right direction, each of the ends of the ejection module 49C overlaps with one of the ends of the ejection modules 49A, 49B.

Each of the ejection modules 49A, 49B, 49C is provided with the plurality of nozzles 38A. Each of the plurality of nozzles 38A is opened in the nozzle surface 50 of each of the ejection modules 49A, 49B, 49C. The nozzle surface 50 is a surface which spreads in the front-rear direction and in the left-right direction. As described above, the ink is discharged downwardly from the plurality of nozzles 38A toward the sheet S supported by the conveying belt 101 of the first supporting mechanism 51 to thereby record an image on the sheet S.

The head 38 is configured to move, along the up-down direction, to a recording position as depicted in FIGS. 19 to 21, to a capping position as depicted in FIG. 17, to a wiping position as depicted by solid lines in FIG. 18, and to an uncap position as depicted by broken lines in FIG. 18. The recording position is a position of the head 38 in a case that the read 38 records an image on the sheet S supported by the conveying belt 101. The capping position is a position of the head 38 in a case that the ejection module 49 is covered by the cap 62 of the maintenance mechanism 60. The capping position is a position which is above or higher than the recording position (a position further apart from the first supporting mechanism 51 than the recording position). The wiping position is a position of the head 38 in a case that the sponge wiper 64 of the maintenance mechanism 60 wipes the nozzle surface 50 of the ejection module 49. The wiping position is a position which is above the capping position. The uncap position is a position of the head 38 in a case that the head 38 is completely away or separated from the maintenance mechanism 60. The uncap position is a position which is above the wiping position.

As depicted in FIG. 2, the head 38 is moved by a ball screw 29. The ball screw 29 has a screw shaft 29A and a nut member 29B. The screw shaft 29A is supported by the lower casing 32 to be rotatable about an axis along the up-down direction. The screw shaft 29A rotates by a driving force transmitted thereto from a head motor 54 (see FIG. 16). The nut member 29B moves upwardly by the normal rotation of the screw shaft 29A and moves downwardly by the reverse rotation of the screw shaft 29A. Note that the configuration for the head 38 to move in the up-down direction is not limited to or restricted by the configuration using the ball screw 29; various kinds of publicly known configurations may be adopted to move the head 38 in the up-down direction.

<First Supporting Mechanism 51>

As depicted in FIGS. 2, 5, and 6, the first supporting mechanism 51 includes the conveying belt 101, a driving roller 102, a driven roller 103, the supporting member 104, a gear 105 and a gear 106. Note that in each of the drawings, the teeth of the gears 105 and 106 are omitted.

The driving roller 102 and the driven roller 103 are rotatably supported by the supporting part 104. The driving roller 102 and the driven roller 103 are separated from each other in the front-rear direction (the conveyance direction). The conveying belt 101 is an endless belt. The conveying belt 101 is stretched between the driving roller 102 and the driven roller 103. The conveying belt 101 is arranged in the inside of the conveyance path 43 in the left-right direction.

The driving roller 102 rotates by a driving force applied thereto by the conveying motor 53 (see FIG. 16) and causes the conveying belt 101 to rotate. The driven roller 103 rotates accompanying with the rotation of the conveying belt 101. The conveying belt 101 has a conveying surface 108. The conveying surface 108 is an upper part of the outer circumferential surface of the conveying belt 101 and extends along the conveyance direction. The conveying surface 108 faces the plurality of nozzles 38A of the head 38 with the conveyance path 43 being interposed therebetween. The conveying surface 108 supports the sheet S which is (being) conveyed between the conveying roller pairs 36, 40 from therebelow while applying a conveying force to the sheet S. With this, the conveying belt 101 conveys the sheet S positioned in the conveyance path 43 in the conveyance direction which is along the conveying surface 108.

As depicted in FIGS. 2 and 5, the supporting part 104 is provided with a shaft 109A. The shaft 109A is rotatably supported by the lower casing 32. The shaft 109A extends in the left-right direction (which is orthogonal to the conveyance direction and parallel to the nozzle surface 50 of the ejection module 49). The shaft 109A is provided on the upstream side in the conveyance direction with respect to the driving roller 102. The shaft 109A is located at a position below the conveying roller pair 36.

The shaft 109A rotates by a driving force transmitted thereto from a shaft motor 59 (see FIG. 16). By the rotation of the shaft 109A, the supporting part 104 rotates about the shaft 109A. A rotational forward end 51A of the first supporting mechanism 51 is located on the downstream side in the conveyance direction with respect to the shaft 109A.

The supporting member 104 is capable of changing the posture thereof to a first posture (see FIG. 2) at which the supporting member 104 is parallel to the nozzle surface 50 of the ejection module 49 and to a second posture (see FIG. 19) at which the supporting member 104 is inclined from the first posture with the shaft 109A as the center of inclination, and the rotational forward end 51A is located at a position lower than the shaft 109A.

As depicted in FIG. 2, in a case that the first supporting mechanism 51 is in the first posture, the conveying surface 108 of the conveying belt 101 extends along the front-rear direction. With this, the conveying belt 101 is capable of conveying the sheet S located in the conveyance path 43 forwardly and conveying the sheet S up to the supporting part 46.

As depicted in FIGS. 19 to 21, in a case that the first supporting mechanism 51 is in the second posture, the conveying surface 108 of the conveying belt 101 extends along an oblique direction which is inclined further downwardly toward further forwardly. Note that the oblique direction is a direction which is orthogonal to the left-right direction and crosses the conveyance direction.

As depicted in FIGS. 5 and 6, the supporting part 104 is provided with a body 109 and standing walls 110, 111. In the following explanation of the supporting part 104, it is assumed that the first supporting mechanism 51 is in the second posture. The body 109 is a member which is generally plate-shaped and is provided with the shaft 109A. The standing wall 110 is provided to stand (is erected) upwardly from a left end part of the body 109. The standing wall 111 is provided to stand upwardly from a right end part of the body 109. The standing walls 110, 111 extend along the oblique direction.

The standing walls 110, 111 are located, in the left-right direction, at the outside of the conveyance path 43. The standing walls 110, 111 rotatably support the driving roller 102 and the driven roller 103.

The standing wall 110 is provided with an upper surface 110A. The standing wall 111 has a first upper surface 111A and a second upper surface 111B. The second upper surface 111B is located at a different position from that of the first upper surface 111A in the left-right direction. The upper surface 110A and the first upper surface 111A support the maintenance mechanism 60 so as to slidably support the movement of the maintenance mechanism 60. As depicted in FIGS. 5 and 8, the second upper surface 111B is located at a position at which the second upper surface 111B is capable of facing a rack 154 (to be described later on) of the maintenance mechanism 60. An opening 112 is formed in the second upper surface 111B. A part of a gear 105A protrudes upwardly from the opening 112. The gear 105A is engageable (is capable of meshing) with the rack 154 which is at a position facing the gear 105A.

As depicted in FIGS. 2 and 5, the gears 105, 106 are rotatably supported by the supporting part 104 of the first supporting mechanism 51. The gear 105 is constructed of gears 105A and 105B which are arranged side by side along the left-right direction. The gears 105A and 105B are arranged coaxially with each other. The gear 105A rotates integrally with the gear 105B. The gear 105B is meshed with the gear 106. The gear 106 is connected to a first motor 55 (see FIG. 16) directly or via another gear, etc., and a driving force from the first motor 55 is applied to the gear 106.

<Second Supporting Mechanism 52>

As depicted in FIG. 2, the second supporting mechanism 52 is arranged in a state that the second supporting mechanism 52 extends in the oblique direction, as a whole, and is movable in the orthogonal direction by a ball screw 160. The ball screw 160 has a screw shaft 161 and a nut member 162. Note that the ball screw 160 driving the second supporting mechanism 52 is depicted only in FIG. 2 and is omitted in the other drawings.

As depicted in FIGS. 2 and 5, the second supporting mechanism 52 is provided with a body 115, standing walls 116, 117, and gears 118, 119, 120. Note that in the respective drawings, the teeth of the gears 118, 119, 120 are omitted.

The body 115 is a member which is generally plate-shaped. The screw shaft 161 of the ball screw 160 is fixed to the body 115 and is screwed to the nut member 162 fixed to the lower casing 32. The screw shaft 161 rotates by a driving force transmitted thereto from an up-down driving motor 163 (see FIG. 16). With this, the body 115 is movable in the orthogonal direction. The configuration for moving the head 38 in the orthogonal direction is not limited to the configuration using the ball screw 160; and variety of kinds of publicly known configuration may be adopted as the configuration for moving the head 38 in the orthogonal direction.

The standing wall 116 is provided to stand upwardly from a left end part of the body 115. The standing wall 117 is provided to stand upwardly from a right end part of the body 115. The standing walls 116, 117 extend along the oblique direction.

The standing wall 116 is at a same position in the left-right direction as that of the standing wall 110 of the first supporting mechanism 51. The standing wall 117 is at a same position in the left-right direction as that of the standing wall 111 of the first supporting mechanism 51.

The standing wall 116 is provided with an upper surface 116A. The standing wall 117 is provided with a first upper surface 117A and a second upper surface 117B. The second upper surface 117B is at a different position in the left-right direction from that of the first upper surface 117A.

In a case that the first supporting mechanism 51 is in the second posture, the first upper surface 117 A is arranged side by side with the first upper surface 111A of the standing wall 111 of the first supporting mechanism 51 along the oblique direction, and is on a same plane as the first upper surface 111A. In other words, the first upper surface 117A and the first upper surface 111A are arranged side by side linearly. In the case that the first supporting mechanism 51 is in the second posture, the second upper surface 117B is arranged side by side with the second upper surface 111B of the standing wall 111 of the first supporting mechanism 51 along the oblique direction and is on a same plane as the second upper surface 111B. In other words, the second upper surface 117B and the second upper surface 111 B are arranged side by side linearly.

The upper surface 116A and the first upper surface 117A support the maintenance mechanism 60 and slidably supports the movement of the maintenance mechanism 60. The second upper surface 117B is located at a position at which the second upper surface 117 is capable of facing (of being opposite to) the rack 154 of the maintenance mechanism 60. As depicted in FIG. 5, openings 123, 124 are formed in the second upper surface 117B. The opening 124 is located in front of (on the front side with respect to) the opening 123. A part of the gear 118 protrudes upwardly from the opening 123. A part of gear 119 protrudes upwardly from opening 124. The gears 118, 119 are capable of meshing with the rack 154 which is located at a position at which the rack 154 faces the gears 118 and 119.

As depicted in FIGS. 2 and 5, the gears 118, 119 and 120 are supported by the body 115 of the second supporting mechanism 52 so that the gears 118, 119 and 120 are rotatable. The gear 118 includes gears 118A, 118B arranged side by side along the left-right direction. The gears 118A and 118B are arranged coaxially with each other. The gear 118A rotates integrally with the gear 118B. The gears 119 includes gears 119A and 119B arranged side by side along the left-right direction. The gears 119A and 119B are arranged coaxially with each other. The gear 119A rotates integrally with the gear 119B. The gear 120 meshed with the gears 118B and 119B. With this, in a case that the gear 120 rotates, the gears 118, 119 rotate in a same direction as the gear 120. The gear 120 is connected directly, or via another gear, etc., to the second motor 56 (see FIG. 16) and a driving force from the second motor 56 is applied to the gear 120.

<Maintenance Mechanism 60>

As depicted in FIGS. 6 and 7, the maintenance mechanism 60 is provided with a supporting stand 61, a sponge wiper 64, a rubber wiper 63 and the cap 62. Note that in the following description of the maintenance mechanism 60, it is assumed that the maintenance mechanism 60 is supported by the first supporting mechanism 51 which is in the second posture and the second supporting mechanism 52.

<Supporting Stand 61>

The supporting stand 61 has a bottom stand 61A, a body 61B placed on the bottom stand 61A, and a wiper holder 61C which holds the sponge wiper 64 and the rubber wiper 63 in the body 61B. The bottom stand 61A has a box shape of which upper part is opened. The bottom stand 61A has a first bottom plate 121, a first edge plate 122 provided to stand upwardly from a peripheral edge of the first bottom plate 121, an extending piece 125 and the rack 154 (see FIG. 8).

The first bottom plate 121 has a shape of a flat plate expanding in the oblique direction and in the left-right direction. An upper surface and a lower surface of the first bottom plate 121 are each formed to have a rectangular shape which is longer in the left-right direction than in the oblique direction. The lower surface of the first bottom plate 121 is capable of making contact with the upper surface 110A of the standing wall 110 of the first supporting mechanism 51 from thereabove. The lower surface of the first bottom plate 121 is capable of making contact with the first upper surface 111A of the standing wall 111 from thereabove. With this, the maintenance mechanism 60 can be supported by the first supporting mechanism 51. The lower surface of the first bottom plate 121 is capable of making contact with the upper surface 116A of the standing wall 116 of the second supporting mechanism 52 from thereabove. The lower surface of the first bottom plate 121 is capable of making contact with the first upper surface 117A of the second supporting mechanism 52 from thereabove. With this, the maintenance mechanism 60 can be supported by the second supporting mechanism 52.

The first edge plate 122 has a shape of a rectangular frame as seen in a plan view. The extending piece 125 extends rightward from a lower end part of a right wall of the first edge plate 122. The extending piece 125 extends from one end to the other end in the oblique direction of the right wall of the first edge plate 122.

The rack 154 is formed in a lower surface of the extending piece 125. As depicted in FIG. 8, the rack 154 extends from one end part in the oblique direction of the extending piece 125 to the vicinity of the other end in the oblique direction of the extending piece 125. The rack 154 is capable of facing, in the up-down direction, the second upper surface 111B of the first supporting mechanism 51 (see FIG. 6).

The rack 154 is capable of meshing with the gear 105A protruding from the opening 112 of the second upper surface 111B. In a case that the gear 105A rotate in a state that the rack 154 and the gear 105A are meshed with each other, the maintenance mechanism 60 thereby slides (slidably moves), with respect to the first supporting mechanism 51, along the upper surface 110A and the first upper surface 111A. Namely, the movement of the maintenance mechanism 60 is guided by the upper surface 110A and the first upper surface 111A of the first supporting mechanism 51A.

The rack 154 is capable of facing, in the up-down direction, the second upper surface 117B of the standing wall 117 of the second supporting mechanism 52. The rack 154 is capable of meshing with the gear 118A protruding from the opening 123 of the second upper surface 117B and the gear 119A protruding from the opening 124 of the second upper surface 117B. In a case that the gear 105A rotates in a state that the rack 154 is meshed with at least one of the gear 118A and the gear 119A, the maintenance mechanism 60 thereby slides along the upper surface 116A and the first upper surface 117A, with respect to the second supporting mechanism 52. Namely, the movement of the maintenance mechanism 60 is guided by the upper surface 116A and the second upper surface 117A of the second supporting mechanism 52A.

With this, the maintenance mechanism 60 is capable of moving to a standby position depicted in FIGS. 2 and 21, to a retreating position depicted in FIG. 22 and FIG. 23, to a maintenance position (an example of a “covering position”) depicted in FIG. 17, and to a wiping position depicted in FIG. 18, as will be described later on. The maintenance mechanism 60 at the maintenance position and at the wiping position faces, in the up-down direction, the nozzle surface 50 of the ejection module 49 of the head 38. The maintenance mechanism 60 at the standby position and at the retreating position is in a state of being away (separated) from the nozzle surface 50.

As depicted in FIG. 7, the body 61B has a shape of substantially a box of which upper part is opened. The body 61B is fixed to the bottom base 61A. The body 61B has a second bottom plate 151, a second edge plate 152 provided to stand upwardly from the second bottom plate 151, and a fluid channel 153 configured to circulate therein the impregnating liquid L stored in the impregnating liquid tank 76.

As depicted in FIGS. 7 and 9, the second bottom plate 151 has a shape of a flat plate expanding in the oblique direction and the left-right direction. An upper surface and a lower surface of the second bottom plate 151 are formed to have a rectangular shape which is longer in the left-right direction than in the oblique direction. The second edge plate 152 has a shape of a rectangular frame in a plan view.

As depicted in FIG. 9, the fluid channel 153 is formed in the upper surface of the second bottom plate 151. The fluid channel 153 is a concave groove (recessed groove) which is recessed downwardly from the upper surface of the second bottom plate 151 and which is opened upwardly. The fluid channel 153 has a continuous shape of a letter “U”, in a plan view, which extends in the left-right direction and is turned (folded) back so as to make a U-turn. The fluid channel 153 extends so that a sponge wiper 64A, a sponge wiper 64B and a sponge wiper 64C which are arranged in the recessed groove are connected in series. The fluid channel 153 has a first channel 153A, an intermediate channel 153B, and a second channel 153C.

The first channel 153A is positioned on the upstream side in a flowing orientation of the impregnating liquid L in the fluid channel 153. The first channel 153A is a part extending in the left-right direction at the front side in the body 61B.

The intermediate channel 153B is positioned on the downstream side in the flowing orientation of the impregnating liquid L with respect to the first channel 153A. The intermediate channel 153B extends from a downstream end of the first channel 153A up to an intermediate part in the oblique direction of the body 61b, in a frontward-inclined orientation (an example of a “frontward orientation”).

The second channel 153C is positioned on the downstream side in the flowing orientation of the impregnating liquid L in the fluid channel 153. The second channel 153C extends rightward from a downstream end of the intermediate channel 153B.

As depicted in FIG. 9, an inflow port 171 via which the impregnating liquid L flows into the first channel 153A is opened in an inner wall surface in the recessed groove at the upstream end of the first channel 153A. One end of a first supply tube 175 is connected to the inflow port 171. The other end of the first supply tube 175 reaches to the outside of the first supporting mechanism 51, is connected to the impregnating liquid tank 76 and opens at a position lower than the water surface of the impregnating liquid L stored in the impregnating liquid tank 76.

An outflow port 174 via which the impregnating liquid L flows out from the second channel 153C is opened in an inner wall surface in the recessed groove at the downstream end of the second channel 153C. One end of a return tube 176 is connected to the outflow port 174. The other end of the return tube 176 reaches the outside of the first supporting mechanism 51, is connected to the impregnating liquid tank 76 and opens at a position higher than the water surface of the impregnating liquid L stored in the impregnating liquid tank 76. A return pump 75 is provided on the return tube 176 (see FIG. 2). The driving of the return pump 75 is controlled by the controller 130.

As depicted in FIG. 7, the wiper holder 61C has the sponge wiper 64 and the rubber wiper 63. The sponge wiper 64 and the rubber wiper 63 are supported with respect to the body 61B by the wiper holder 61C.

<Sponge Wiper 64>

The sponge wiper 64 is formed of a sponge. In the present embodiment, the sponge wiper 64 is provided as three sponge wipers 64 (64A, 64B, 64C). In the following, the three sponge wipers 64A, 64B, 64C are collectively referred also to as the sponge wiper 64. The sponge wiper 64 is formed to have a shape of a rectangular of which length in the left-right direction is longer than a length thereof in the oblique direction and a length thereof in the up-down direction. The length in the up-down direction of the sponge wiper 64 is longer than the length in the oblique direction of the sponge wiper 64.

The sponge wiper 64A and the sponge wiper 64B are arranged in the fluid channel 153A. The sponge wiper 64A is arranged on the upstream side with respect to the sponge wiper 64B. The sponge wiper 64C is arranged in the second channel 153C of the fluid channel 153.

The sponge wiper 64A, the sponge wiper 64B and the sponge wiper 64C correspond, respectively, to the ejection module 49A, the ejection module 49B and the ejection module 49C with respect to the up-down direction. The sponge wiper 64A and the sponge wiper 64B are positioned with respect to each other with a spacing distance therebetween in the left-right direction. The sponge wiper 64C is positioned at a spacing distance in the frontward-inclined orientation with respect to the sponge wiper 64A and the sponge wiper 64B. The sponge wiper 64C is positioned at an intermediate between the sponge wiper 64A and the sponge wiper 64B in the left-right direction.

The sponge wiper 64A corresponds to the ejection module 49A and is capable of facing the ejection module 49A in the up-down direction. As depicted in FIGS. 7 and 9, the sponge wiper 64A is positioned on the right side with respect to the center in the left-right direction of the first channel 153.

<Rubber Wiper 63>

The rubber wiper 63 is formed of rubber. In the present embodiment, the rubber wiper 63 is provided as three rubber wipers 63 (63A, 63B, 63C). In the following, the three rubber wipers 63A, 63B, 63C are collectively referred also to as the rubber wiper 63.

The rubber wiper 63 is formed to have a shape of a flat plate expanding in the up-down direction and the left-right direction. A length in the oblique direction of the rubber wiper 63 is shorter than the length in the oblique direction of the sponge wiper 64. With this, the rubber wiper 63 is easily bent in a case that the rubber wiper 63 makes contact with the nozzle surface 50 of the ejection module 49 in a case that the wiping processing is (being) performed. A length in the left-right direction of the rubber wiper 63 is slightly longer than the length in the left-right direction of the sponge wiper 64. A length from the supporting stand 61 of the rubber wiper 63 is longer than a length from the supporting stand 61 of the sponge wiper 64. The rubber wiper 63 is positioned at the outside in the left-right direction of both ends in the left-right direction of the sponge wiper 64. An upper end part of the rubber wiper 63 is formed to be tapered. With this, the upper end part of the rubber wiper 63 easily makes contact with the nozzle surface 50 of the ejection module 49 in a case that the wiping processing is (being) performed.

The rubber wiper 63A and the rubber wiper 63B are arranged at the outside of the fluid channel 153. The rubber wiper 63A, the rubber wiper 63B and the rubber wiper 63C correspond, respectively, to the ejection module 49A, the ejection module 49B and the ejection module 49C with respect to the up-down direction. The rubber wiper 63A, the rubber wiper 63B and the rubber wiper 63C are arranged in the supporting stand 61, with spacing distances, respectively, from the sponge wiper 64A, the sponge wiper 64B and the sponge wiper 64C in a rearward-inclined orientation.

<Cap 62>

As depicted in FIG. 7, the cap 62 is supported on a supporting stand 61. The cap 62 is provided as a plurality of caps 62. In the present embodiment, the cap 62 is constructed of three caps 62A, 62B and 62C. In the following description, the three caps 62A, 62B, 62C are collectively referred also to as the cap 62.

The cap 62 is formed of an elastic material such as rubber, silicone, etc. The cap 62 has a shape of a box of which upper part is opened.

The cap 62A, the cap 62B and the cap 62C are capable of facing, respectively, the ejection module 49A, the ejection module 49B and the ejection module 49C in the up-down direction. The cap 62A, the cap 62B and the cap 62C are arranged to be apart, respectively, from the sponge wiper 64A, the sponge wiper 64B and the sponge wiper 64C, with a spacing distance therebetween in the frontward-oblique direction. The cap 62A, the cap 62B and the cap 62C are configured such that in a case that the maintenance mechanism 60 is located at the maintenance position, a lip 66A, a lip 66B and a lip 66C make contact with the nozzle surface 50 and seal, respectively, an internal space 67A, an internal space 67B and an internal space 67C. The caps 62A, 62B and 62C have, respectively, cap channels (each an example of a “liquid channel”) connecting, respectively, the internal spaces 67A, 67B, 67C to the outside thereof. The cap channels 68A, 68B, 68C have, respectively, inflow channel 20A, 20B, 20C via which the impregnating liquid L flows, respectively, into the internal spaces 67A, 67B, 67C of the caps 62A, 62B, 62C; the cap channels 68A, 68B, 68C have, respectively, outflow channel 21A, 21B, 21C via which the impregnating liquid L flows out, respectively, from the internal spaces 67A, 67B, 67C of the caps 62A, 62B, 62C.

In the following, the three lips 66A, 66B, 66C will be collectively referred also to as a lip 66. Further, the internal spaces 67A, 67B, 67C, the cap channels 68A, 68B, 68C, the inflow channels 20A, 20B, 20C, and the outflow channels 21A, 21B, 21C are similarly collectively referred, respectively, also as to an internal space 67, a cap channel 68, an inflow channel 20 and an outflow channel 21.

As depicted in FIG. 10, the cap 62A corresponds to the ejection module 49A and is capable of facing the ejection module 49A in the up-down direction. The cap 62A is arranged with a spacing distance from the sponge wiper 64A in the frontward-inclined orientation. A bottom plate 69 of the cap 62A has the inflow channel 20A which is formed in the bottom plate 69 and through which the impregnating liquid L flows into the cap 62A and the outflow channel 21A which is formed in the bottom plate 69 and through which the impregnating liquid L flows out of the cap 62A. One end of a second supply tube 177 is connected to the inflow channel 20A of the cap 62A. The other end of the second supply tube 177 reaches to the outside of the maintenance mechanism 60 and is connected to the impregnating liquid tank 76 (see FIG. 2). One end of a first waste liquid tube 178 is connected to the outflow channel 21A. The other end of the first waste liquid tube 178 reaches to the outside of the maintenance mechanism 60 and is connected to the waste liquid tank 77 (see FIG. 2).

The cap 62B corresponds to the ejection module 49B and is capable of facing the ejection module 49B in the up-down direction. The cap 62B is arranged with a spacing distance from the sponge wiper 64B in the frontward-inclined orientation. A bottom plate 69 of the cap 62B has the inflow channel 20B which is formed in the bottom plate 69 and through which the impregnating liquid L flows into the cap 62B and the outflow channel 21B which is formed in the bottom plate 69 and through which the impregnating liquid L flows out of the cap 62B. One end of a third supply tube 179 branched from the second supply tube 177 is connected to the inflow channel 20B of the cap 62B. The other end of the third supply tube 178 is joined to the second supply tube 177 at the outside of the maintenance mechanism 60. One end of a second waste liquid tube 180 is connected to the outflow channel 21B. The other end of the second waste liquid tube 180 is joined to the first waste liquid tube 178 at the outside of the maintenance mechanism 60.

The cap 62C corresponds to the ejection module 49C and is capable of facing the ejection module 49C in the up-down direction. The cap 62C is arranged with a spacing distance from the sponge wiper 64C in the frontward-inclined orientation. A bottom plate 69 of the cap 62C has the inflow channel 20C which is formed in the bottom plate 69 and through which the impregnating liquid L flows into the cap 62C and the outflow channel 21C which is formed in the bottom plate 69 and through which the impregnating liquid L flows out of the cap 62C. One end of a fourth supply tube 201 branched from the second supply tube 177 is connected to the inflow channel 20C of the cap 62C. The other end of the fourth supply tube 201 is joined to the second supply tube 177 at the outside of the maintenance mechanism 60. One end of a third waste liquid tube 202 is connected to the outflow channel 21C. The other end of the third waste liquid tube 202 is joined to the first waste liquid tube 178 at the outside of the maintenance mechanism 60.

A cap washing valve 72 (see FIG. 16) is provided on the upstream side with respect to a branching point at which the third supply tube 179 and the fourth supply tube 201 are branched in the second supply tube 177. The opening and closing of the cap washing valve 72 is controlled by the controller 130.

The suction pump 74 (see FIG. 2) is provided on the downstream side with respect to a joining point at which the second waste liquid tube 180 and the third waste liquid tube 202 are jointed in the first waste liquid tube 178. Driving of the suction pump 74 is controlled by the controller 130. Note that the suction pump 74 may be provided on each of the first waste liquid tube 178, the second waste liquid tube 180, and the third waste liquid tube 202.

<Wiper Cleaning Mechanism 80>

As depicted in FIGS. 2 and 14, the wiper cleaning mechanism 80 is positioned at a location below the supporting part 46, and the wiper cleaning mechanism 80 has a supporting member 81 and a lid member 82. The wiper cleaning mechanism 80 is connected to a lower part of the supporting part 46 via an elastic member 83. The wiper cleaning mechanism 80 is pivotably (rockably) supported along the orthogonal direction with respect to the supporting part 46.

As depicted in FIGS. 11 and 12, the supporting member 81 has a shape which is generally a flat plate. The supporting member 81 is configured so that the lid member 82 is detachably installable in the supporting member 81. The supporting member 81 has a facing surface 81A facing the lid member 82 installed in the supporting member 81, a left edge wall 84A extending downwardly from a left-side edge of the supporting member 81, a right edge wall 84B extending downwardly from a right-side edge of the supporting member 81, a left inner wall 84C extending downwardly at a location on the right side in the left-right direction of the left edge wall 84A, a right inner wall 84D extending downwardly at a location on the left side in the left-right direction of the right edge wall 84A, and a regulating shaft 97.

The facing surface 81A is a lower-side surface of the supporting member 81.

The left inner wall 84C has a supporting piece 85B and a guiding surface 86B.

The supporting piece 85A is a projection which projects or protrudes from the left inner wall 84C to the right side in the left-right direction. The supporting piece 85A is provided as a plurality of supporting pieces 85A arranged along the oblique direction.

The guiding surface 86A is a projected part (protruded part) which guides installment of the lid member 82 in the supporting member 81. The guiding surface 86A projects from the left inner wall 84C to the right side in the left-right direction. The guiding surface 86A is located at a position which is in the frontward-inclined orientation with respect to the supporting piece 85A. The guiding surface 86A has one end side extending in the rearward-inclined orientation, and the other end side extending further away (separated) from the facing surface 81A as the other end side is further in the frontward-inclined orientation.

The right inner wall 84D has a supporting piece 85B and a guiding surface 86B, similarly to the left inner wall 84C.

The supporting piece 85B of the right inner wall 84D has a similar configuration as that of the above-described projecting piece 85A, except that the supporting piece 85B projects from the right inner wall 84D to the left side in the left-right direction. The supporting piece 85A and the supporting piece 85B support the lid member 82 from therebelow.

The guiding surface 86B of the right inner wall 84D has a similar configuration as that of the above-described guiding surface 86A, except that the guiding surface 86B projects from the right inner wall 84D to the left side in the left-right direction.

The regulating shaft 97 regulates movement in the rearward-inclined orientation of the installed lid member 82. The regulating shaft 97 is formed to have a shape of a shaft on the facing surface 81A. The regulating shaft 97 is arranged at a central position in the left-right direction at a part on the front side of the supporting member 81.

Further, the supporting member 81 has an installment sensor 87 (see FIG. 12 and FIG. 14; an example of a “sensor”) which is configured to detect that the lid member 82 is installed.

As depicted in FIGS. 2, 11, 13 and 14, the lid member 82 faces the maintenance mechanism 60 which is located at the retreating position in a state that the lid member 82 is installed in the supporting member 81. The lid member 82 has a shape which is generally a flat plate, and has a lower surface 88, an upper surface 89 and a cutout part (notched part) 98.

The lid member 82 has a holding member 90 in the lower surface 88. The holding member 90 is formed of a sponge and is capable of holding (retaining) the ink. The holding member 90 makes contact with the lip 66 and the rubber wiper 63 which are located at the retreating position (see FIG. 14). With this, the holding member 90 wipes the ink off the lip 66 and the rubber wiper 63. The holding member 90 seals the internal space 67 of the cap 62 which is located at the retreating position.

As depicted in FIGS. 13, 14 and 15, the lid member 82 has a rib 91 protruding in the upper surface 89 toward the supporting member 81, a left operating part 92A arranged in a left-side area of the upper surface 89, a right operating part 92B arranged in a right-side area of the upper surface 89. The left operating part 92A and the right operating part 92B are arranged, as a pair of operating parts 92A and 92B, to be apart from each other in the left-right direction, on the side of the front inclined orientation 5 of the upper surface 89. The operating parts 92A, 92B are members configured to release engagement of the lid member 82 with respect to the supporting member 81.

The rib 91 is detectable by the installment sensor 87 in a state that the lid member 82 is installed in the supporting member 81. The rib 91 is arranged in the center in the oblique direction of the upper surface 89 and at an area on the left side. The rib 91 has a shape of a flat plate and extends along the oblique direction.

The left operating part 92A has a shape of a flat plate and extends along the oblique direction in the upper surface 89. The left operating part 92A is integrally formed with the rib 91. The left operating part 92A has an end part on the rearward-inclined orientation which is fixed to the upper surface 89. Namely, the left operating part 92A is capable of rocking in the left-right direction with the end part on the side of the rearward-inclined orientation as the fulcrum. The left operating part 92A has a left engaging part 93A projecting leftward at a central position in the oblique direction of the left operating part 92A.

The left engaging part 93A is formed on a left-side surface of the left operating part 92A. The left engaging part 93A has a left contacting surface 95A which is a surface spreading in the left-right direction and in the orthogonal direction, and a left inclined surface 94A which is inclined, from the left-side surface of the left operating part 92A, further toward the left side as approaching further closely toward the frontward-inclined orientation and connecting (linking) to the left contacting surface 95A.

The right operating part 92B has a configuration which is similar to that of the left operating part 92A, except that the right operating part 92B has a right engaging part 93B projecting toward the right side at a central position in the oblique direction of the right operating part 92B. Thus, any further explanation of the right operating part 92B will be omitted.

The right engaging part 93B is formed in a right-side surface of the right operating part 92B. The right engaging part 93B has a right contacting surface 95B which is a surface spreading in the left-right direction and the orthogonal direction, and a right inclined surface 94B which is inclined, from the right-side surface of the right operating part 92B, further toward the right side as approaching further closely in the frontward-inclined orientation and connecting (linking) to the right contacting surface 95B. The left engaging part 93A and the right engaging part 93B are a pair of engaging parts 93A, 93B which is engaged with a locking part 96 (see FIGS. 12 and 15) formed in the supporting member 81.

The cutout part 98 makes contact with the regulating shaft 97 and regulates the movement in the rearward-inclined orientation of the lid member 82 with respect to the supporting member 81 of the lid member 82. The cutout part 98 is arranged in a central position in the left-right direction at a part on the front side of the lid member 82. The cutout part 98 is opened in the rearward-inclined orientation.

In a case that the lid member 82 installed in the supporting member 81 slides (slidably moves) in the frontward-inclined orientation with respect to the supporting member 81, the contact surfaces 95A, 95B make contact with the locking part 96 formed in the supporting member 81 to thereby regulate the movement of the lid member 82. The user is capable of detaching (disengaging) the engaging parts 93A and 93B from the locking part 96 by moving the left operating part 92A to the right side in the left-right direction and by moving the right operating part 92B to the left side in the left-right direction. In this state, the user is capable of sliding the lid member 82 in the frontward-inclined orientation to thereby detach (disengage) the lid member 82 from the supporting member 81.

Further, the user is also capable of installing the lid member 82 in the supporting member 81 by moving an insertion forward end of the lid member 82 in the rearward-inclined orientation to be along the guiding surfaces 86A, 86B. Specifically, in a case that the lid member 82 is inserted into the supporting member 81, the left engaging part 93A is pressed to the right side by the locking part 96 to thereby deform the left operating part 92A rightward, and the right engaging part 93B is pressed to the left side by the locking part 96 to thereby deform the right operating part 92B leftward. In a case that the lid member 82 is pushed further in the rearward-inclined orientation, the engaging parts 93A, 93B ride over the locking part 96 and then the contacting surfaces 95A, 95B engage with the locking part 96. In this situation, since the cutout part 98 makes contact with the regulating shaft 97, the movement in the rearward-inclined orientation of the lid member 82 with respect to the supporting part 81 is also regulated. Note that it is sufficient that the operating parts 92A, 92B, the engaging parts 93A, 93B, the locking part 96, the cutout part 98 and the regulating shaft 97 are capable of regulating the movement of the lid member 82 installed in the supporting member 81 in the oblique direction, and that any other publicly known configuration for each of the operating parts 92A, 92B, the engaging parts 93A, 93B, the locking part 96, the cutout part 98 and the regulating shaft 97 may be adopted.

<Controller 130>

As depicted in FIG. 16, the controller 130 includes a CPU 131, a ROM 132, a RAM 133, an EEPROM 134 and an ASIC 135 which are connected by an internal bus 137. The ROM 132 stores a program, etc., for controlling a variety of kinds of operations of the CPU 131. The RAM 133 is used as a memory area configured to temporarily store data, signal, etc., to be used by the CPU 131 for executing the program, or is used as a work space for executing data processing. The EEPROM 134 stores a setting, a flag, etc., to be retained even after the power is turned off.

The conveying motor 53, the head motor 54, the first motor 55, the second motor 56, a return pump motor 47, a suction pump motor 58, the shaft motor 59, the up-down driving motor 163, a valve motor 71, the operation panel 44, the installment sensor 87, and the display 44A are connected to the ASIC 135.

The ASIC 135 generates a drive signal for rotating each of the motors and controls each of the motors based on this drive signal. Each of the motors rotates forward or backward (rotates normally or reversely) based on the drive signal from the ASIC 135. The controller 130 controls the driving of the conveying motor 53 so as to rotate the holder 35, the conveying roller 36A, the conveying roller 40A and the driving roller 102. The controller 130 controls the driving of the head motor 54 so as to rotate the screw shaft 29A, thereby moving the head 38 along the up-down direction. The controller 130 controls the driving of the shaft motor 59 so as to rotate (pivot) the first supporting mechanism 151. The controller 130 controls the driving of the first motor 55 so as to rotate the gear 106 of the first supporting mechanism 51. The controller 130 controls the driving of the up-down driving motor 163 so as to rotate the screw shaft 161, thereby moving the second supporting mechanism 52 along the orthogonal direction. The controller 130 controls the driving of the second motor 56 so as to rotate the gear 120 of the second supporting mechanism 52. The controller 130 controls the driving of the return pump motor 78 so as to drive the return pump 75. The controller 130 controls the driving of the suction pump motor 58 so as to drive the suction pump 74. The controller 130 controls the driving of the valve motor 71 so as to open and close the cap cleaning valve 72. The controller 130 controls the driving of the valve motor 73 so as to cause the impregnating liquid circulating valve 141 to open and close.

Further, the operation panel 44, the display 44A and a piezoelectric element (not depicted in the drawings) are connected to the ASIC 135. The operation panel 44 outputs an operation signal to the controller 130 in accordance with an operation by the user. The operation panel 44 may have, for example, a push button and/or may have a touch sensor overlaid on a display. The display 44A indicates that the lid member 82 is installed in the supporting member 81. The piezoelectric element is operated in case that the electric power is supplied to the piezoelectric element by the controller 130 via a non-illustrated drive circuit. The controller 130 controls the power supply to the piezoelectric element to thereby selectively discharge an ink droplet of the ink from the plurality of nozzles 38A.

Furthermore, the installment sensor 87 is electrically connected to the ASIC 35. The controller 130 detects insertion and detachment (removal) of the lid member 82 via the installment sensor 87.

In the following, an operation of the maintenance mechanism 60 will be described, together with a purging processing, an immersion processing, a wiping processing and an image recording processing. In the present embodiment, the supply and discharge (exhaust) of the impregnating liquid L is performed together with the above-described processings.

<Purging Processing and Immersion Processing>

The image recording apparatus 100 in a case that the image recording processing is not (being) executed is in a standby state. In a case that the image recording apparatus 100 is in the standby state, as depicted in FIG. 17, the head 38 is located at the capping position, the first supporting mechanism 51 assumes (is in) the first posture in a state that the first supporting mechanism 51 supports the maintenance mechanism 60, and the maintenance mechanism 60 is located at the maintenance position. In this situation, the cap 62 covers the nozzle surface 50.

In a case that the image recording apparatus 100 is in the standby state, the controller 130 executes the purging processing at a predetermined timing or in a case that the controller 130 receives an instruction from the outside. In the following, an explanation will be given about a processing (to be executed) in a case that the image recording apparatus 100 is in the standby state and that the controller 130 receives, from the outside, an instruction or command to execute the purging processing.

In the purging processing, the controller 130 drives the suction pump 74 in a state that the controller 130 closes the cap cleaning valve 72. With this, the ink in the inside of the plurality of nozzles 38A is sucked and the ink flows from the internal spaces 67A, 67B, 67C of the cap 62 and through the outflow channels 21A, 69B, 69C; the ink flows through the first waste liquid tube 178, the second waste liquid tube 180 and the third waste liquid tube 202 and then the ink is discharged (exhausted) to the waste liquid tank 77. In this situation, since the cap cleaning valve 72 is closed, the impregnating liquid L is not supplied from the impregnating liquid tank 76 to the caps 62A, 62B, 62C via, respectively, the second supply tube 177, the third supply tube 179 and the fourth supply tube 201.

The controller 130 executes the immersion processing at a predetermined timing or in a case that the controller 130 receives an instruction from the outside. In the following, an explanation will be given about a processing (to be executed) in a case that the controller 130 executes the immersion processing after the purging processing has been executed in the case that the image recording apparatus 100 has been in the standby state.

In the immersion processing, the controller 130 drives the suction pump 74 in a state that the cap cleaning valve 72 is opened. With this, the impregnating liquid L is supplied from the impregnating liquid tank 76 to the caps 62A, 62B, 62C, respectively, through the second supply tube 177, the third supply tube 179 and the fourth supply tube 201, and the plurality of nozzles 38A of the ejection module 49 is immersed in the impregnating liquid L. As a result, the ink adhering to the nozzle surface 50 is dissolved in the impregnating liquid L and is discharged (exhausted), together with the impregnating liquid L, into the waste liquid tank 77.

In a case that the immersion processing is completed, the controller 130 moves the head 38 to the uncap position and separates the head 38 from the maintenance mechanism 60 located at the maintenance position; before the above-described operation, however, the controller 130 drives the impregnating liquid circulating valve 141 so as to provide a state that the atmospheric communicating channel 140 is closed and drives the return pump 75. With this, the impregnating liquid L is supplied from the impregnating liquid tank 76 to the supporting stand 61 through the first supply tube 175. The impregnating liquid L supplied to the supporting stand 61 flows into the first channel 135A in the fluid channel 153 through the inflow port 171. The impregnating liquid L inflowed into the first channel 153A flows into the intermediate channel 153B and the second channel 153C in this order, and is exhausted from the outflow port 174. In this situation, there is provided a state that the sponge wipers 64A, 64B, 64C are impregnated with the impregnating liquid L and that the sponge wipers 64A, 64B, 64C are fully impregnated with the impregnating liquid L. Note that in a case that the head 38 is moved to the uncap position, there is provided a state that the impregnating liquid L is adhered to the lips 66A, 66B, 66C.

The controller 130 drives the impregnating liquid circulating valve 141 so as to provide a state that the atmospheric communicating channel 140 is opened, and the controller 130 drives the return pump 75. With this, the impregnating liquid L discharged from the outflow port 174 is returned to the impregnating liquid tank 76 through the return tube 176.

<Wiping Processing>

The controller 130 executes the wiping processing in a state that the sponge wipers 64A, 64B, 64C are impregnated with the impregnating liquid L. The wiping processing will be explained as follows.

The controller 130 moves the head 38 downwardly to thereby move the head 38 from the uncap position indicated by broken lines in FIG. 18 to the wiping position indicated by the solid line in FIG. 18.

On the other hand, although the maintenance mechanism 60 at the maintenance position is supported by the first supporting mechanism 51, the rack 154 meshes with the gear 105 in this situation. In a case that the first motor 55 is driven in this state so as to rotate the gear 106 clockwise in FIG. 17, the gear 105 rotates counterclockwise in FIG. 17. With this, the maintenance mechanism 60 at the maintenance position moves frontward (the downstream in the conveyance direction) along the front-rear direction (conveyance direction), and arrives at the wiping position (see FIG. 18).

In a process in which the maintenance mechanism 60 is (being) moved from the maintenance position to the wiping position, a forward end part (upper end part) of each of the sponge wiper 64 and the rubber wiper 63 slides with respect to the nozzle surface 50 of the ejection module 49 while the forward end part (upper end part) of each of the sponge wiper 64 and the rubber wiper 63 is making contact with the nozzle surface 50. Specifically, the sponge wipers 64A, 64B, 64C and the rubber wipers 63A, 63B, 63C slide in a state that the sponge wipers 64A, 64B, 64C and the rubber wipers 63A, 63B, 63C make contact with, respectively, the nozzle surfaces 50 of the ejection modules 49A, 49B, 49C. With this, the nozzle surfaces 50 of the respective ejection modules 49A, 49B, 49C are wiped. As a result, a foreign matter, etc., adhered to the nozzle surface 50 and/or the plurality of nozzles 38A opened in the nozzle surface 50 is removed.

In a case that the maintenance mechanism 60 is located at the wiping position, the first motor 55 is driven so as to rotate the gear 106 rotates counterclockwise in FIG. 18, the gear 105 rotates clockwise in FIG. 18. With this, the maintenance mechanism 60 at the wiping position moves rearward (toward the upstream side in the conveyance direction) and arrives at the maintenance position (see FIG. 17).

The controller 130 drives the shaft motor 59 so as to change the posture of the first supporting mechanism 51 from the first posture to the second posture (see FIG. 19).

<Movement of Maintenance Mechanism 60>

As depicted in FIGS. 19 to 21, the maintenance mechanism 60 is capable of moving to the standby position along the oblique direction by slidably moving with respect to the first supporting mechanism 51 which is in the second posture and the second supporting mechanism 52 in a state that the maintenance mechanism 60 is supported by the first supporting mechanism 51 and the second supporting mechanism 52. Namely, the first supporting mechanism 51 and the second supporting mechanism 52 are capable of supporting the maintenance mechanism 60 which is located at the maintenance position, the standby position and a position between the both positions (the maintenance and standby positions).

Specifically, the controller 130 drives the first motor 55 at first. With this, since the gear 106 rotates clockwise in FIG. 19, the gear 105 rotates counterclockwise in FIG. 19, thereby causing the maintenance mechanism 60 at the maintenance position to move in the frontward-inclined orientation to be handed onto (received by) the second supporting mechanism 52 (see FIG. 20).

The controller 130 drives the second motor 56. With this, since the gear 120 rotates clockwise in FIG. 20, the gears 118, 119 rotate counterclockwise in FIG. 20, thereby causing the maintenance mechanism 60 which has been slidably moved from the first supporting mechanism 51 arrives at the standby position on the second supporting mechanism 52 (see FIG. 21).

The controller 130 drives the up-down driving motor 163. With this, since the screw shaft 161 rotates, the second supporting mechanism 52 moves upward from the standby position along the orthogonal direction (an example of a direction crossing a surface of the holding member 90), and the maintenance mechanism 60 arrives at the retreating position (see FIG. 22). In this situation, the supporting member 81 urges the lid member 82 toward the caps 62A, 62B, 62C by the elastic member 83. There is provided a state that the holding member 90 makes contact with the lips 66A, 66B, 66C and the rubber wipers 63A, 63B, 63C of the caps 62A, 62B, 62C, respectively. The sponge wipers 64A, 64B, 64C are in a state of being separated away from the holding member 90.

Further, the caps 62A, 62B, 62C are arranged to overlap with a range, in the conveyance direction of the sheet S, which is occupied by the heater 39. Specifically, as depicted in FIG. 22, a range P1 in the conveyance direction (the front-rear direction) occupied by the heater 39 (hereinafter referred also to as a range of the heater 39) and a range P2 occupied by parts, respectively of the cap 62C and 62B, ranging from a front side in the oblique direction of the cap 62C and a rear side in the oblique direction of the cap 62B (hereinafter referred also to as a range of the cap 62) overlap. In the present embodiment, as a case of partially overlapping arrangement, a front side part of the range P1 of the heater 39 and a rear side part of the range P2 of the cap 62 overlap. In this situation, since the wiper cleaning mechanism 80 is positioned between the caps 62A, 62B, 62C and the heater 39, the heat from the heater 39 is shielded by the wiper cleaning mechanism 80, thereby making the heat from the heater 39 to less likely to be transmitted to the caps 62A, 62B, 62C.

<Image Recording Processing>

In the following, a processing in a case of recording an image on the sheet S (image recording processing) will be explained.

In a case that the controller 130 receives a command of recording an image on a sheet S, from the operation panel or from an external apparatus or device such as an information processing apparatus which is connected to the image recording apparatus 100 by a LAN, etc., the controller 130 moves the maintenance mechanism 60 from the maintenance position to the standby position, as descried above. Then, the controller 130 drives the up-down driving motor 163 so as to move the maintenance mechanism 60 from the standby position to the retreating position. The controller 130 drives the shaft motor 59 so as to change the posture of the first supporting mechanism 51 from the second posture to the first posture (see FIG. 23).

Next, the controller 130 moves the head 38 downward to thereby move the head 38 from the capping position to the recording position (see FIG. 23). Then, the controller 130 starts the conveyance of the sheet S, and discharges the ink from the plurality of nozzles 38 in a state that the sheet S is positioned immediately below the head 38. With this, an image is recorded on the sheet S. The ink adhered onto the sheet S is fixed by being irradiated with an infrared light in a case that the sheet S passes (is passing) the heater 39. The sheet S which is further conveyed is subjected to checking of the recorded image by the CIS 25, then is cut by the cutter unit 26 to a predetermined size, and is discharged from the image recording apparatus 100.

In a case that the maintenance mechanism 60 is moved to the maintenance position after the image recording processing with respect to the sheet S, a processing (steps) which is reverse to that described above will be performed.

Specifically, the controller 130 drives the up-down driving motor 163 at first. With this, the screw shaft 161 rotates so as to move the second supporting mechanism 52 downward from the retreating position along the orthogonal direction, and the maintenance mechanism 60 arrives at the standby position. In this situation, the lips 66A, 66B, 66C, the rubber wipers 63A, 63B, 63C and the sponge wipers 64A, 64B, 64C of the caps 62A, 62B, 62C, respectively, are in a state of being away from the holding member 90 of the lid member 82 (see FIG. 21).

Next, the controller 130 drives the shaft motor 59 so as to change the posture of the first supporting mechanism 51 from the first posture to the second posture (see FIG. 21). In this situation, the maintenance mechanism 60 is supported by the second supporting mechanism 52. In this state, the rack 154 meshes with both of the gears 118, 119. In a case that the second motor 56 (see FIG. 16) is driven and that the gear 120 rotates counterclockwise in FIG. 21, the gears 118, 119 rotate clockwise in FIG. 21. With this, the maintenance mechanism 60 at the standby position moves in the rearward-inclined orientation (see FIG. 20).

The controller 130 drives the first motor 55. With this, since the gear 106 rotates counterclockwise in FIG. 20, the gear 105 rotates clockwise and the maintenance mechanism 60 which has been slidably moved from the second supporting mechanism 52 reaches on the first supporting mechanism 51 (see FIG. 19).

The shaft motor 59 (see FIG. 16) is driven in a state that the maintenance mechanism 60 is supported by the first supporting mechanism, thereby rotating the first supporting mechanism 51 form the second posture to the first posture. Further, the head 38 is moved from the wiping position to the capping position. With this, the maintenance mechanism 60 is located at the maintenance position (see FIG. 17). The maintenance mechanism 60 at the maintenance position is positioned between the head 38 and the first supporting mechanism 51 which is in the first posture.

<Technical Effect of Embodiment>

Since the lid member 81 makes contact with the cap 62 at the retreating position and the internal space 67 is sealed thereby, the heat of the heater 39 located above the cap 62 is shielded by the lid member 82. Further, the internal space 67 of the cap 62 is sealed by the lid member 82. With this, although the cap 62 is warmed or heated by the heat from the heater 39, the cap 62 is tightly closed by the lid member 82, and thus the ink is less likely to evaporate, thereby suppressing any clogging of the cap channel 68.

In a case that the cap 62 is located at the retreating position, since the ink adhered to the lip 66 of the cap 62 is retained by the holding member 90, the ink does not dry and solidify in the lip 66 of the cap 62.

Since the lid member 82 is detachably installable with respect to the supporting member 81, it is possible to exchange the lid member 82 to thereby make it possible to always maintain the holding member 90 to be in such a state that the holding member 90 is capable of retaining the ink in a case that the lip 66 of the cap 62 makes contact with the holding member 90. Accordingly, it is possible to maintain the lip 66 of the cap 62 to be in a clean state.

The lid member 82 can be detached from the supporting member 81 by slidably moving the lid member 82 in the frontward-inclined orientation with respect to the casing 30 of the image recording apparatus 100. Accordingly, the operation of exchanging the lid member 82 can be performed easily.

Since the lid member 82 can be installed along the guide member 86 of the supporting member 81, the lid member 82 can be easily installed in the supporting member 81.

Since the lid member 82 can be disengaged from the supporting member 81 by operating the operating part 92, the lid member 82 can be easily detached from the supporting member 81.

Since the installment sensor 87 detects that the lid member 82 is installed in the supporting member 81, it is possible for the user to confirm whether the lid member 82 is successfully installed in the supporting member 81 in an ensured manner.

Since the lid member 82 is urged by the elastic member 83 toward the cap 62 in a case that the cap 62 is located at the retreating position, the lid member 82 is tightly brought into contact with the cap 62.

In a case that the lid member 82 is being in the state of sealing the internal space 67 of the cap 62, although the rubber wiper 63 makes contact with the holding member 90 and the ink is thereby absorbed, the sponge wiper 64 does not contact with the holding member 90 and thus the ink is not absorbed. Accordingly, it is possible to wipe the ink adhered to the rubber wiper 63 by the holding member 90, and it is also possible to suppress such a situation that the impregnating liquid L moves from the sponge wiper 64 to the holding member 90, that an amount of the impregnating liquid L included in the holding member 90 becomes great and that the impregnating liquid L drips downward from the holding member 90.

The maintenance mechanism 60 moves such that the rubber wiper 63 does not slide in a state that the rubber wiper 63 makes contact with the holding member 90. Accordingly, it is possible to suppress such a situation that the ink absorbed and retained by the holding member 90 is squeezed out by, for example, the rubber wiper 63 making contact with the holding member 90, due to the movement of the maintenance mechanism 60.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

<Modifications>

In the image recording apparatus 100, although the fluid channel 153 is formed to have the shape of the letter “U” which extends in the left-right direction and is turned (folded) back so as to make the U-turn, the fluid channel 153 is not limited to or restricted by having the shape of the letter “U”, provided that the impregnating liquid L circulating or flowing through the fluid channel 153 is capable of making contact with the sponge wiper 64. The fluid channel 153 may also be formed, for example, in a linear shape extending in the left-right direction.

In the image recording apparatus 100, although the sponge wiper 64 has the three sponge wipers 64A, 64B, 64C, the number of the sponge wiper 64 is not limited to being 3 (three), provided that the number of the sponge wiper 64 corresponds to the number of the ejection module 49. For example, the number of the sponge wiper 64 may be not less than 4 (four), or not more than 2 (two).

In the image recording apparatus 100, although the three rubber wipers 63A, 63B, 63C are provided on the supporting stand 61, the number of the rubber wiper 63 is not particularly limited, provided that the number of the rubber wiper 63 corresponds to the number of the ejection module 49. For example, the number of the rubber wiper 63 may be not less than 4 (four), or not more than 2 (two). Alternatively, the rubber wiper 63 may be omitted.

In the image recording apparatus 100, although the three caps 62A, 62B, 62C are provided on the supporting stand 61, the number of the cap 62 is not particularly limited, provided that the number of the cap 62 corresponds to the number of the ejection module 49. For example, the number of the cap 62 may be not less than 4 (four), or not more than 2 (two).

In the image recording apparatus 100, although the maintenance mechanism 60 moves frontward from the maintenance position to thereby move to the wiping position, it is allowable that the maintenance mechanism 60 moves rearward from the maintenance position to thereby move to the wiping position. In such a case, the sponge wiper 64 may be positioned on the rear side with respect to the rubber wiper 63.

In the image recording apparatus 100, in the wiping processing, although the sponge wiper 64 and the rubber wiper 63 move with respect to the head 38 in a state that the head 38 is located at the wiping position, it is allowable that the head 38 moves with respect to the sponge wiper 64 and the rubber wiper 63 in a state that the positions, respectively, of the sponge wiper 64 and the rubber wiper 63 are fixed.

In the image recording apparatus 100, the explanation has been given about the case, as an example, wherein the maintenance mechanism 60 is supported by the first supporting mechanism 51 and the second supporting mechanism 52, and wherein in a case that the maintenance mechanism 60 is moved to the maintenance position and to the standby position, the maintenance mechanism 60 is handed and received between the first supporting mechanism 51 and the second supporting mechanism 52, the present disclosure is not limited to or restricted by this configuration. For example, it is allowable that the first supporting mechanism 51 and the second supporting mechanism 52 are integrally formed, and that the first supporting mechanism 51 and the second supporting mechanism 52 are capable of changing the posture thereof to the first posture and the second posture, and that the maintenance mechanism 60 is capable of being supported by such a configuration.

In the image recording apparatus 100, the explanation has been given about the case, as an example, wherein the lid member 82 is caused to slide in the frontward inclined orientation 5 with respect to the casing 30 so that the lid member 82 can be detached from the casing 30. The present disclosure, however, is not limited to or restricted by this configuration. It is allowable that the lid member 82 is configured, for example, to be detached in a direction crossing the up-down direction.

In the image recording apparatus 100, the explanation has been given about the case, as an example, wherein, in the conveying direction, the range P1 of the heater 39 and the range P2 of the cap 62 overlap in the conveying direction. It is allowable, however, that specifically, the range P1 of the heater 39 and the range P2 of the cap 62 overlap partially or overlap completely with each other in the conveying direction. In the present embodiment, although the explanation has been given about the case, as an example, wherein the front side part of the range P1 of the heater 39 and the rear side part of the range P2 of the cap 62 overlap, it is also allowable to provide such a configuration that a front side part of the range P2 of the cap 62 and a rear side part of the range P1 of the heater 39 overlap. Alternatively, it is also allowable to provide such a configuration that all the range P1 of the heater 39 is included in the range P2 of the cap 62; still alternatively, it is allowable to provide such a configuration that all the range P1 of the heater 39 is included in the range P2 of the cap 62.

What is claimed is:

1. A liquid discharge apparatus comprising:
a head including a nozzle surface and a nozzle opened in the nozzle surface;
a cap configured to make contact with the nozzle surface at a covering position and configured to be separated away from the nozzle surface at a retreating position;
a liquid channel configured to communicate an internal space of the cap and outside of the cap to each other;
a lid member configured to make contact with the cap located at the retreating position to seal the internal space of the cap; and
a heater positioned above the cap located at the retreating position, wherein
the lid member is positioned between the heater and the cap in an up-down direction in a state that the lid member seals the internal space of the cap.

2. The liquid discharge apparatus according to claim 1, wherein
a range occupied by the cap and a range occupied by the heater are overlapped in a conveyance direction of a medium.

3. The liquid discharge apparatus according to claim 1, wherein
the lid member includes a holding member configured to hold a liquid, and
the holding member is configured to make contact with a lip of the cap located at the retreating position so as to seal the internal space of the cap.

4. The liquid discharge apparatus according to claim 3, further comprising a supporting member configured to support the lid member, wherein
the lid member is configured to be detachably installed to the supporting member.

5. The liquid discharge apparatus according to claim 4, further comprising a casing in which an internal space accommodating the head, the cap, the lid member and the heater is defined, wherein
a discharge port configured to discharge a medium on which the liquid discharged from the head is adhered is provided on a front surface of the casing, and
the lid member is configured to slide frontward with respect to the supporting member so as to be detached from the supporting member.

6. The liquid discharge apparatus according to claim 4, wherein
the supporting member includes:
a supporting piece configured to support the lid member; and
a guiding surface extending rearward toward the supporting piece.

7. The liquid discharge apparatus according to claim 4, wherein
the lid member includes:
an engaging part configured to engage with the supporting member in a state that the lid member is supported by the supporting member; and
an operating part configured to release engagement of the engaging part with respect to the supporting member.

8. The liquid discharge apparatus according to claim 4, further comprising a sensor configured to detect the lid member installed in the supporting member.

9. The liquid discharge apparatus according to claim 4, wherein
the supporting member further includes an elastic member configured to urge the lid member toward the cap in a state that the cap is located at the retreating position.

10. The liquid discharge apparatus according to claim 3, further comprising:
a water absorbing wiper;
a non-water absorbing wiper; and
a moving member which is configured to support the cap, the water absorbing wiper and the non-water absorbing wiper, the moving member being configured to move the cap to the retreating position and to the covering position, wherein
in the state that the lid member seals the internal space of the cap, the water absorbing wiper is separated away from the holding member and the non-water absorbing wiper makes contact with the holding member.

11. The liquid discharge apparatus according to claim 10, wherein
the moving member is configured to move in a direction crossing a surface of the holding member so as to move the cap to the retreating position and to the covering position.
